(19) United States
(12) Patent Application Publication
(10) Pub. No.: US 2024/0205990 A1
(43) Pub. Date: Jun. 20, 2024

(54) BASE STATION ASSISTANCE FOR USER EQUIPMENT DISCOVERY

(71) Applicant: QUALCOMM Incorporated, San Diego, CA (US)

(72) Inventors: Fang YUAN, Beijing (CN); Jelena DAMNJANOVIC, Del Mar, CA (US); Aleksandar DAMNJANOVIC, Del Mar, CA (US); Luanxia YANG, Beijing (CN); Jing SUN, San Diego, CA (US); Yan ZHOU, San Diego, CA (US); Tao LUO, San Diego, CA (US); Rajat PRAKASH, San Diego, CA (US); Xiaoxia ZHANG, San Diego, CA (US)

(21) Appl. No.: 18/572,122

(22) PCT Filed: Aug. 26, 2021
(86) PCT No.: PCT/CN2021/114711

§ 371 Date: Dec. 19, 2023

(51) Int. Cl. H04W 76/14; H04W 8/00; H04W 88/04

(52) U.S. Cl. CPC H04W 76/14; H04W 8/005; H04W 88/04

(57) ABSTRACT

Methods, systems, and devices for wireless communications are described. A user equipment (UE) may communicate with a base station using UE cooperation. For example, a first UE may transmit an uplink signal indicating a request for the base station to transmit a UE discovery request signal to a second UE. In response to transmitting the uplink signal, the first UE may receive a sidelink signal from the second UE. The sidelink signal may indicate that the second UE may be available for a cooperative link with the first UE. In some cases, based on the sidelink signal, the first UE may establish the cooperative link with the second UE. In some examples, based on establishing the cooperative link, the first UE may receive downlink communications from the base station via at least sidelink communications from the second UE over the cooperative link.

### CROSS REFERENCE

The present Application is a 371 national stage filing of International PCT Application No. PCT/CN2021/114711 by YUAN et al. entitled “BASE STATION ASSISTANCE FOR USER EQUIPMENT DISCOVERY,” filed Aug. 26, 2021, which is assigned to the assignee hereof, and which is expressly incorporated by reference in its entirety herein.

### FIELD OF TECHNOLOGY

The following relates to wireless communications, including base station assistance for user equipment discovery.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some examples, a wireless communications system may support uplink and downlink communications between a base station and multiple UEs. Additionally or alternatively, the wireless communications system may support sidelink communications between the UEs.

### SUMMARY

The described techniques relate to improved methods, systems, devices, and apparatuses that support base station assisted user equipment (UE) discovery. Generally, the described techniques enable a base station to forward a UE discovery request to other UEs in the system, which may improve a likelihood of establishing a cooperative UE link and increase a system throughput or reliability, among other advantages. For example, a first UE may transmit an uplink signal to a base station. The uplink signal may, in some cases, indicate a request for the base station to transmit a UE discovery request signal to one or more UEs, and hence to at least a second UE. The base station may transmit the UE discovery request signal via a downlink message to the one or more UEs in the system (e.g., the second UE). Thus, as a result of transmitting the uplink signal, the first UE may receive a sidelink signal from the second UE indicating that the second UE is available for a cooperative link with the first UE, due to the discovery request signal having been transmitted by the base station in response to the initial uplink signal from the first UE. In some cases, the first UE may establish the cooperative link with the second UE based on the sidelink signal. The cooperative link may enable the first UE to receive downlink communications from the base station via at least sidelink communications from the second UE over the cooperative link (e.g., the first UE may receive downlink communications from the base station via a direct link with the base station and sidelink communications from the second UE via the cooperative link).

A method for wireless communications at a first UE is described. The method may include transmitting, to a base station, an uplink signal indicating a request for the base station to transmit a UE discovery request signal to at least a second UE, receiving, from the second UE, a sidelink signal based on transmitting the uplink signal, the sidelink signal indicating that the second UE is available for a cooperative link with the first UE, establishing the cooperative link with the second UE based on receiving the sidelink signal, and receiving downlink communications from the base station via at least sidelink communications from the second UE over the cooperative link based on establishing the cooperative link with the second UE.

An apparatus for wireless communications at a first UE is described. The apparatus may include a processor, memory coupled with the processor, and instructions stored in the memory. The instructions may be executable by the processor to cause the apparatus to transmit, to a base station, an uplink signal indicating a request for the base station to transmit a UE discovery request signal to at least a second UE, receive, from the second UE, a sidelink signal based on transmitting the uplink signal, the sidelink signal indicating that the second UE is available for a cooperative link with the first UE, establish the cooperative link with the second UE based on receiving the sidelink signal, and receive downlink communications from the base station via at least sidelink communications from the second UE over the cooperative link based on establishing the cooperative link with the second UE.

Another apparatus for wireless communications at a first UE is described. The apparatus may include means for transmitting, to a base station, an uplink signal indicating a request for the base station to transmit a UE discovery request signal to at least a second UE, means for receiving, from the second UE, a sidelink signal based on transmitting the uplink signal, the sidelink signal indicating that the second UE is available for a cooperative link with the first UE, means for establishing the cooperative link with the second UE based on receiving the sidelink signal, and means for receiving downlink communications from the base station via at least sidelink communications from the second UE over the cooperative link based on establishing the cooperative link with the second UE.

A non-transitory computer-readable medium storing code for wireless communications at a first UE is described. The code may include instructions executable by a processor to transmit, to a base station, an uplink signal indicating a request for the base station to transmit a UE discovery request signal to at least a second UE, receive, from the second UE, a sidelink signal based on transmitting the uplink signal, the sidelink signal indicating that the second UE is available for a cooperative link with the first UE, establish the cooperative link with the second UE based on receiving the sidelink signal, and receive downlink communications from the base station via at least sidelink communications from the second UE over the cooperative link based on establishing the cooperative link with the second UE.

Some examples of the method, apparatuses, and non-transitory computer-readable medium described herein may further include operations, features, means, or instructions for transmitting, to the base station, one or more indications each corresponding to a respective criterion for the cooperative link associated with the UE discovery request signal.

In some examples of the method, apparatuses, and non-transitory computer-readable medium described herein, the one or more indications include an indication of a sidelink type for the cooperative link, an indication of a latency for the cooperative link, an indication of a quality of service associated with the cooperative link, or any combination thereof.

Some examples of the method, apparatuses, and non-transitory computer-readable medium described herein may further include operations, features, means, or instructions for transmitting, to the base station, one or more indications each corresponding to a respective criterion for the second UE.

In some examples of the method, apparatuses, and non-transitory computer-readable medium described herein, the one or more indications include an indication of a frequency band associated with a second direct link associated with the second UE, an indication of a transmit power associated with the second direct link, or any combination thereof.

Some examples of the method, apparatuses, and non-transitory computer-readable medium described herein may further include operations, features, means, or instructions for transmitting, to the base station, an indication of a location of the first UE, an indication of one or more locations associated with the cooperative link, an indication of the second UE, an indication of a group of UEs including the second UE, or any combination thereof.

Some examples of the method, apparatuses, and non-transitory computer-readable medium described herein may further include operations, features, means, or instructions for transmitting, to at least the second UE prior to transmitting the uplink signal, a sidelink UE discovery request signal to establish the cooperative link and monitoring for a response to the sidelink UE discovery request signal, where transmitting the uplink signal to the base station may be based on failing to receive the response to the sidelink UE discovery request signal.

A method for wireless communications at a second UE is described. The method may include receiving, from a base station and while operating in an idle mode, a UE discovery request signal corresponding to a first UE, transmitting, to the first UE, a sidelink signal based on receiving the UE discovery request signal from the base station, the sidelink signal indicating that the second UE is available for a cooperative link with the first UE, establishing the cooperative link with the first UE based on transmitting the sidelink signal, receiving downlink communications from the base station via a direct link with the base station, and transmitting sidelink communications to the first UE via the cooperative link, the sidelink communications corresponding to the downlink communications received from the base station.

An apparatus for wireless communications at a second UE is described. The apparatus may include a processor, memory coupled with the processor, and instructions stored in the memory. The instructions may be executable by the processor to cause the apparatus to receive, from a base station and while operating in an idle mode, a UE discovery request signal corresponding to a first UE, transmit, to the first UE, a sidelink signal based on receiving the UE discovery request signal from the base station, the sidelink signal indicating that the second UE is available for a cooperative link with the first UE, establish the cooperative link with the first UE based on transmitting the sidelink signal, receive downlink communications from the base station via a direct link with the base station, and transmit sidelink communications to the first UE via the cooperative link, the sidelink communications corresponding to the downlink communications received from the base station.

Another apparatus for wireless communications at a second UE is described. The apparatus may include means for receiving, from a base station and while operating in an idle mode, a UE discovery request signal corresponding to a first UE, means for transmitting, to the first UE, a sidelink signal based on receiving the UE discovery request signal from the base station, the sidelink signal indicating that the second UE is available for a cooperative link with the first UE, means for establishing the cooperative link with the first UE based on transmitting the sidelink signal, means for receiving downlink communications from the base station via a direct link with the base station, and means for transmitting sidelink communications to the first UE via the cooperative link, the sidelink communications corresponding to the downlink communications received from the base station.

A non-transitory computer-readable medium storing code for wireless communications at a second UE is described. The code may include instructions executable by a processor to receive, from a base station and while operating in an idle mode, a UE discovery request signal corresponding to a first UE, transmit, to the first UE, a sidelink signal based on receiving the UE discovery request signal from the base station, the sidelink signal indicating that the second UE is available for a cooperative link with the first UE, establish the cooperative link with the first UE based on transmitting the sidelink signal, receive downlink communications from the base station via a direct link with the base station, and transmit sidelink communications to the first UE via the cooperative link, the sidelink communications corresponding to the downlink communications received from the base station.

Some examples of the method, apparatuses, and non-transitory computer-readable medium described herein may further include operations, features, means, or instructions for receiving the UE discovery request signal from the base station via a broadcast message.

In some examples of the method, apparatuses, and non-transitory computer-readable medium described herein, the broadcast message includes a paging channel message, a system information message, a message communicated over a broadcast channel corresponding to UE cooperation, or any combination thereof.

Some examples of the method, apparatuses, and non-transitory computer-readable medium described herein may further include operations, features, means, or instructions for activating sidelink communications at the second UE in response to receiving the UE discovery request signal from the base station, where transmitting the sidelink signal may be based on enabling the sidelink communications.

Some examples of the method, apparatuses, and non-transitory computer-readable medium described herein may further include operations, features, means, or instructions for receiving one or more indications each corresponding to a respective criterion for the cooperative link associated with the UE discovery request signal, a respective criterion for the second UE, or any combination thereof.

In some examples of the method, apparatuses, and non-transitory computer-readable medium described herein, the one or more indications include an indication of a sidelink type for the cooperative link, an indication of a latency for the cooperative link, an indication of a quality of service associated with the cooperative link, an indication of a frequency band associated with the direct link, an indication of a transmit power associated with the direct link, an indication of a location of the first UE, an indication of one or more locations associated with the cooperative link, an indication of the second UE, an indication of a group of UEs including the second UE, or any combination thereof.

A method for wireless communications at a base station is described. The method may include receiving, from a first UE, an uplink signal indicating a request for the base station to transmit a UE discovery request signal to at least a second UE, transmitting, to at least the second UE and based on receiving the uplink signal, the UE discovery request signal corresponding to the first UE, receiving, from at least one of the first UE or the second UE, an indication of a cooperative link between the first UE and the second UE based on transmitting the UE discovery request signal, and transmitting, to the first UE and the second UE, downlink communications for the first UE via a first direct link with the first UE and a second direct link with the second UE.

An apparatus for wireless communications at a base station is described. The apparatus may include a processor, memory coupled with the processor, and instructions stored in the memory. The instructions may be executable by the processor to cause the apparatus to receive, from a first UE, an uplink signal indicating a request for the base station to transmit a UE discovery request signal to at least a second UE, transmit, to at least the second UE and based on receiving the uplink signal, the UE discovery request signal corresponding to the first UE, receive, from at least one of the first UE or the second UE, an indication of a cooperative link between the first UE and the second UE based on transmitting the UE discovery request signal, and transmit, to the first UE and the second UE, downlink communications for the first UE via a first direct link with the first UE and a second direct link with the second UE.

Another apparatus for wireless communications at a base station is described. The apparatus may include means for receiving, from a first UE, an uplink signal indicating a request for the base station to transmit a UE discovery request signal to at least a second UE, means for transmitting, to at least the second UE and based on receiving the uplink signal, the UE discovery request signal corresponding to the first UE, means for receiving, from at least one of the first UE or the second UE, an indication of a cooperative link between the first UE and the second UE based on transmitting the UE discovery request signal, and means for transmitting, to the first UE and the second UE, downlink communications for the first UE via a first direct link with the first UE and a second direct link with the second UE.

A non-transitory computer-readable medium storing code for wireless communications at a base station is described. The code may include instructions executable by a processor to receive, from a first UE, an uplink signal indicating a request for the base station to transmit a UE discovery request signal to at least a second UE, transmit, to at least the second UE and based on receiving the uplink signal, the UE discovery request signal corresponding to the first UE, receive, from at least one of the first UE or the second UE, an indication of a cooperative link between the first UE and the second UE based on transmitting the UE discovery request signal, and transmit, to the first UE and the second UE, downlink communications for the first UE via a first direct link with the first UE and a second direct link with the second UE.

Some examples of the method, apparatuses, and non-transitory computer-readable medium described herein may further include operations, features, means, or instructions for receiving, from the first UE, one or more indications each corresponding to a respective criterion for the cooperative link associated with the UE discovery request signal.

In some examples of the method, apparatuses, and non-transitory computer-readable medium described herein, the one or more indications include an indication of a sidelink type for the cooperative link, an indication of a latency for the cooperative link, an indication of a quality of service associated with the cooperative link, or any combination thereof.

Some examples of the method, apparatuses, and non-transitory computer-readable medium described herein may further include operations, features, means, or instructions for receiving, from the first UE, one or more indications each corresponding to a respective criterion for the second UE.

Some examples of the method, apparatuses, and non-transitory computer-readable medium described herein may further include operations, features, means, or instructions for receiving, from at least the second UE, a capability message indicating a capability of the second UE, where transmitting the UE discovery request signal to the second UE may be based on the capability of the second UE satisfying the respective criterion for the second UE.

Some examples of the method, apparatuses, and non-transitory computer-readable medium described herein may further include operations, features, means, or instructions for receiving one or more indications from the first UE, the one or more indications including an indication of a location of the first UE, an indication of one or more locations associated with the cooperative link, an indication of the second UE, an indication of a group of UEs including the second UE, or any combination thereof, where transmitting the UE discovery request signal may be based on receiving the one or more indications.

Some examples of the method, apparatuses, and non-transitory computer-readable medium described herein may further include operations, features, means, or instructions for transmitting, to at least the second UE, one or more indications each corresponding to a respective criterion for the cooperative link associated with the UE discovery request signal, a respective criterion for the second UE, or any combination thereof.

In some examples of the method, apparatuses, and non-transitory computer-readable medium described herein, the one or more indications include an indication of a sidelink type for the cooperative link, an indication of a latency for the cooperative link, an indication of a quality of service associated with the cooperative link, an indication of a frequency band associated with the second direct link, an indication of a transmit power associated with the second direct link, an indication of a location of the first UE, an indication of one or more locations associated with the cooperative link, an indication of the second UE, an indication of a group of UEs including the second UE, or any combination thereof.

Some examples of the method, apparatuses, and non-transitory computer-readable medium described herein may further include operations, features, means, or instructions for transmitting the UE discovery request signal to at least the second UE via a broadcast message.

In some examples of the method, apparatuses, and non-transitory computer-readable medium described herein, the broadcast message includes a paging channel message, a system information message, a message communicated over a broadcast channel corresponding to UE cooperation, or any combination thereof.

Some examples of the method, apparatuses, and non-transitory computer-readable medium described herein may further include operations, features, means, or instructions for receiving, from the first UE, a request for multiple transmission reception point operation, selecting, based on receiving the request for multiple transmission reception point operation, a group of UEs based on each UE in the group of UEs being served by a first transmission reception point different than a second transmission reception point serving the first UE, and transmitting the UE discovery request signal to the selected group of UEs, the selected group of UEs including the second UE.

In some examples of the method, apparatuses, and non-transitory computer-readable medium described herein, transmitting the downlink communications may include operations, features, means, or instructions for transmitting the downlink communications via the first direct link associated with the second transmission reception point and via the second direct link associated with the first transmission reception point.

Some examples of the method, apparatuses, and non-transitory computer-readable medium described herein may further include operations, features, means, or instructions for receiving, from the first UE, a request for multiple user multiple input multiple output operation, selecting, based on receiving the request for multiple user multiple input multiple output operation, a group of UEs based on each UE in the group of UEs being served by a first beam different than a second beam serving the first UE, where a spatial separation between the first beam and the second beam satisfies a threshold, and transmitting the UE discovery request signal to the selected group of UEs, the selected group of UEs including the second UE.

In some examples of the method, apparatuses, and non-transitory computer-readable medium described herein, transmitting the downlink communications may include operations, features, means, or instructions for transmitting the downlink communications via the first direct link associated with the second beam and via the second direct link associated with the first beam.

Some examples of the method, apparatuses, and non-transitory computer-readable medium described herein may further include operations, features, means, or instructions for selecting a group of UEs based on each UE in the group of UEs being associated with a location for the cooperative link, a UE group identifier associated with the cooperative link, a UE identifier associated with the cooperative link, or any combination thereof and transmitting the UE discovery request signal to the selected group of UEs, the selected group of UEs including the second UE.

### BRIEF DESCRIPTION OF THE DRAWINGS

FIGS. 1 and 2 illustrate examples of wireless communications systems that support base station assistance for user equipment (UE) discovery in accordance with aspects of the present disclosure.

FIG. 3 illustrates an example of a process flow that supports base station assistance for UE discovery in accordance with aspects of the present disclosure.

FIGS. 4 and 5 show block diagrams of devices that support base station assistance for UE discovery in accordance with aspects of the present disclosure.

FIG. 6 shows a block diagram of a communications manager that supports base station assistance for UE discovery in accordance with aspects of the present disclosure.

FIG. 7 shows a diagram of a system including a device that supports base station assistance for UE discovery in accordance with aspects of the present disclosure.

FIGS. 8 and 9 show block diagrams of devices that support base station assistance for UE discovery in accordance with aspects of the present disclosure.

FIG. 10 shows a block diagram of a communications manager that supports base station assistance for UE discovery in accordance with aspects of the present disclosure.

FIG. 11 shows a diagram of a system including a device that supports base station assistance for UE discovery in accordance with aspects of the present disclosure.

FIGS. 12 through 15 show flowcharts illustrating methods that support base station assistance for UE discovery in accordance with aspects of the present disclosure.

### DETAILED DESCRIPTION

A wireless communications system may support both direct links and sidelinks for communications between wireless devices. A direct link may refer to a communication link between a user equipment (UE) and a base station (e.g., a Uu interface). For example, a direct link may support uplink signaling and downlink signaling between the UE and the base station. A sidelink may refer to a communication link between similar wireless devices (e.g., a communication link between UEs, for example via a PC5 interface, or a backhaul communication link between base stations such as an integrated access and backhaul (IAB) communication link). It is noted that while various examples provided herein are discussed for UE sidelink devices, such sidelink techniques may be used for any type of wireless communications devices (e.g., UEs, base stations, etc.) that use sidelink communications. For example, a sidelink may support device-to-device (D2D) communication, vehicle-to-everything (V2X), cellular V2X (C-V2X), or vehicle-to-vehicle (V2V) communication, proximity-based services (ProSe) communication, PC5 communication, IAB communication, message relaying, discovery signaling, beacon signaling, or any combination of these or other signals transmitted over-the-air from between devices. In some instances, various sidelink connections between sidelink devices may be used to support data flows between the devices.

Some wireless communications systems may support user equipment (UE) cooperation. For example, active UEs in a network may not utilize all spatial dimensions in the network. Accordingly, network available resources may be under-utilized and network throughout may be reduced. In some cases, to increase network throughput, the wireless communications system may support UE cooperation. During UE cooperation, a set of UEs may collectively exchange information with a base station. For example, a UE of the set (e.g., a target UE) may establish a cooperative link (e.g., a sidelink) with one or more other UEs of the set (e.g., cooperative UEs). In some cases, a base station may communicate with the target UE via a first communication link (e.g., a Uu link) and the base station may communicate with a cooperative UE via a second communication link (e.g., a Uu link). In such cases, the cooperative UE may act as a relay and transmit (e.g., via the established cooperative link between the cooperative UE and the target UE) information received from the base station to the target UE. Similarly, the cooperative UE may transmit (e.g., via the Uu link) information received from the target UE to the base station. Thus, a virtual device may be formed by aggregating a target device and a cooperative device. For example, the base station may use multiple beams, transmission reception points, or both to communicate the same data to the “virtual UE” including the target UE and one or more cooperative UEs.

However, in some cases one or more potential cooperative UEs may be operating in a power saving mode (e.g., a radio resource control (RRC) idle state) such that sidelink communications at the one or more potential cooperative UEs may be disabled. In such cases, the potential cooperative UEs may not receive a sidelink UE discovery request from the target UE (e.g., even if they have the capability to be a cooperative UE for the target UE), and accordingly a cooperative link may not be established.

In accordance with the techniques described herein, a target UE may request assistance from a base station to establish UE cooperation with one or more cooperative UEs. For example, the target UE may transmit an uplink signal to a base station indicating a request for the base station to assist the target UE with a UE discovery request. In some examples, the uplink signal may include or be an example of a UE discovery request that the base station may forward to one or more other UEs in the system. In some cases, the uplink signal may include an indication of one or more criteria for establishing the cooperative link. For example, the indication may include information related to a sidelink type (e.g., Wi-Fi, Bluetooth, or an NR sidelink, among other examples of types of sidelinks), a sidelink latency (e.g., a target or expected latency threshold for sidelink communications), or one or more UE capabilities (e.g., threshold capability for cooperative UEs), such as a transmit power or one or more supported frequency bands. Additionally or alternatively, the indication may include information related to an area in which the UE discovery request may be transmitted. For example, the indication may include a target UE location, a cooperative UE location, a UE ID, or a UE group ID.

In response to receiving the request, the base station may broadcast (e.g., via a Uu link) or otherwise transmit a UE discovery request on behalf of the target UE. In some cases, the base station may broadcast the UE discovery request via a paging control channel (PCCH) message, via a system information (SI) message, or via a message transmitted using a dedicated broadcasting channel for UE cooperation. In some examples, a potential cooperative UE operating in an idle mode may receive the broadcasted UE discovery request. In response to receiving the UE discovery request, the potential cooperative UE may activate sidelink communications and establish a cooperative link with the target UE. One or more aspects of the subject matter described herein may be implemented to realize one or more advantages. In some instances, base station assistance with cooperative UE discovery may increase the probability of UE cooperation within the wireless communications system. Additionally or alternatively, the described techniques may support improvements in wireless communications systems by increasing network throughput (e.g., by improving the ability of UEs to form virtual UEs). Additionally or alternatively, base station assisted UE discovery as described herein may support higher data rates, thereby improving latency and reliability. As such, the described techniques may result in improved network operations and network efficiencies, among other benefits.

Aspects of the disclosure are initially described in the context of wireless communications systems. Aspects of the disclosure are then described in the context of an example process flow. Aspects of the disclosure are further illustrated by, and described with reference to, apparatus diagrams, system diagrams, and flowcharts that relate to base station assisted UE discovery for establishing UE cooperation.

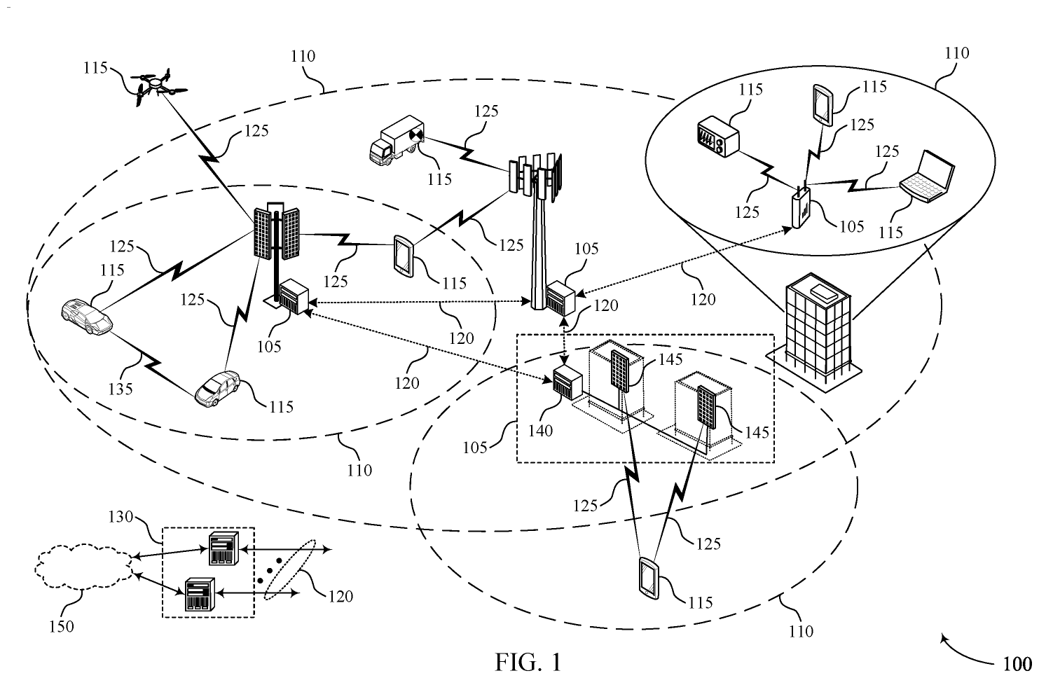

FIG. 1 illustrates an example of a wireless communications system 100 that supports base station assistance for UE discovery in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may support one or more aspects for base station assisted UE discovery. For example, a first UE 115 may transmit an uplink signal to a base station 105. The uplink signal may, in some cases, indicate a request for the base station 105 to transmit a UE discovery request signal to at least a second UE 115. The base station 105 may transmit the UE discovery request signal via a downlink message to one or more UEs 115 in the system (e.g., the second UE 115). As a result of the downlink message (and hence of transmitting the uplink signal), the first UE 115 may receive a sidelink signal from the second UE 115 indicating that the second UE 115 is available for a cooperative link with the first UE 115. In some cases, the first UE 115 may establish the cooperative link with the second UE 115 based on the sidelink signal. The cooperative link may enable the first UE 115 to receive downlink communications from the base station 105 via a direct link with the base station 105 and sidelink communications from the second UE 115 via the cooperative link. In some cases, the second UE 115 may activate sidelink communications in response to receiving the discovery request signal via the downlink message from the base station 105.

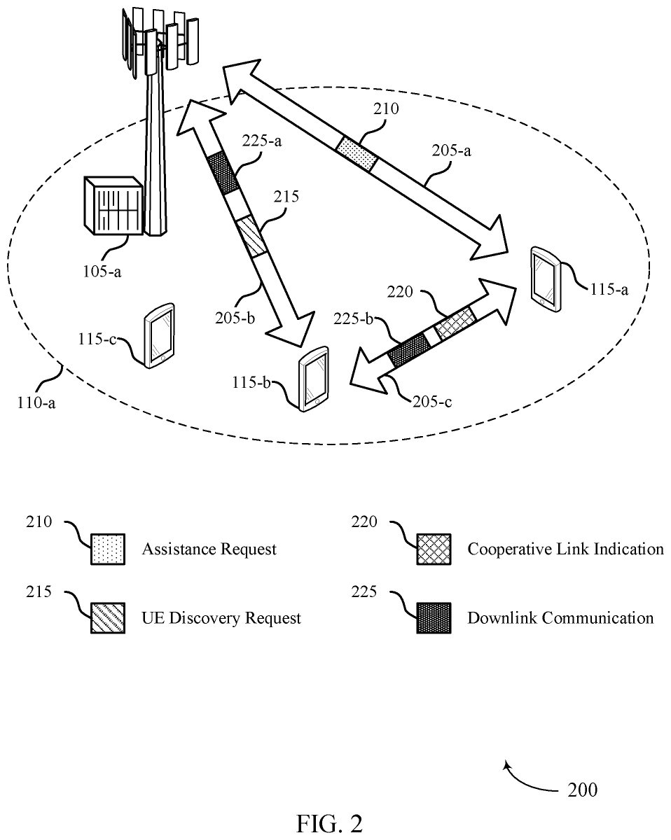

FIG. 2 illustrates an example of a wireless communications system 200 that supports base station assistance for UE discovery in accordance with aspects of the present disclosure. In some examples, wireless communications system 200 may implement aspects of wireless communications system 100. For instance, the wireless communications system 200 may include a base station 105-a, a UE 115-a, a UE 115-b, and a UE 115-c, which may be examples of the corresponding devices described with reference to FIG. 1. The UEs 115 and the base station 105-a may communicate within a geographic coverage area 110-a which may be an example of a geographic coverage area 110 described with reference to FIG. 1.

As depicted in the example of FIG. 2, the UE 115-a may communicate with the base station 105-a via a communication link 205-a, and the UE 115-b may communicate with the base station 105-a via a communication link 205-b. In some examples, the communication link 205-a and the communication link 205-b may be direct links that support uplink communications and downlink communications (e.g., Uu links), which may additionally or alternatively be referred to as access links. In some examples, the UE 115-a and the UE 115-b may communicate via a communication link 205-c. In some cases, the communication link 205-c may be a sidelink as described herein (e.g., a Wi-Fi sidelink, a Bluetooth sidelink, an NR sidelink, or any other types of sidelinks). Additionally or alternatively, the UE 115-c may communicate with the devices of wireless communications system 200, for example, via a respective direct link or sidelink. The wireless communications system 200 may include features for base station assisted UE discovery, among other benefits.

In some examples, active UEs in a network may not utilize all spatial dimensions in the wireless communications system 200 (e.g., an NR network or another network as described herein). In some such examples, available resources in the network may be under-utilized and network throughput or reliability may be relatively poor. Accordingly, the techniques described herein may support UE cooperation. In UE cooperation, one or more UEs 115 may transmit one or more UE discovery request signals to establish a cooperative link (e.g., a sidelink between a target UE 115 and a cooperative UE 115) for UE cooperation. For example, the UE 115-a may identify that the UE 115-b is a cooperative UE based on receiving a response to a discovery request signal from the UE 115-b and establishing the cooperative link (e.g., a sidelink shown by communication link 205-c) with the UE 115-b. If a cooperative link is established, the UEs 115 may use the cooperative link to exchange information.

In some examples of UE cooperation, a base station may transmit communications to the target UE via a communication link with the target UE (e.g., a Uu link with the UE 115-a) and a communication link with the cooperative UE (e.g., a Uu link with the UE 115-b, the UE 115-c, or both). Thus, for example, the target UE and one or more cooperative UEs may aggregate into a virtual UE to increase the utilization of network available resources and, accordingly, increase network throughput. For example, the base station may transmit the same information or data on different beams, TRPs, or both to the various UEs in the virtual UE, and the cooperative UEs may forward such information to the target UE via the cooperative link(s). In some examples, the virtual UE may adopt characteristics of the target UE (e.g., identifiers or capabilities), and the network may unknowingly communicate with the cooperative UE. For example, in some cases, the cooperative UE may appear to the network or otherwise interact with the network as one or more additional antenna panels of the target UE, beyond the quantity of one or more antenna panels that may be physically included in the target UE. As such, the utilization of network available resource may be increased. In some cases, however, one or more cooperative UEs may be operating in a power saving mode (e.g., in an RRC idle state) such that sidelink communications at the one or more cooperative UEs may be disabled, for example, during a time period (e.g., the sidelink communications may be temporally disabled). Stated alternatively, although a cooperative UE may have both direct and sidelink capabilities and may be a candidate for a cooperative link, sidelink communications at the cooperative UE may be disabled (e.g., to save power). In such cases, the cooperative UEs may not receive sidelink communications (e.g., the UE discovery request signal) from the target UE and, as such, may not be reachable by the target UE. In other words, potential cooperative UEs may appear hidden to the target UE (e.g., UEs with sidelink communications disable may appear hidden to the target UE).

As an illustrative example, the UE 115-b and the UE 115-c may be operating in an RRC idle state (e.g., may be potential cooperative UEs with disabled sidelink communications). In such examples, the UE 115-b and the UE 115-c may not receive UE discovery signals from a target UE (e.g., the UE 115-a) on sidelink. For example, the UE 115-b may not receive UE discovery signals from the UE 115-a via the communication link 205-c. In such cases, although the UE 115-b and the UE 115-c may be operating in an RRC idle state (e.g., may have sidelink communications disabled), the UE 115-b and the UE 115-c may monitor for broadcast signals (e.g., broadcast information) from one or more base stations (e.g., the base station 105-a) via a Uu link. Therefore, in some cases, the UE 115-a may transmit an uplink signal indicating a request (e.g., an assistance request 210) to the base station 105-a via the communication link 205-a (e.g., a Uu link). In some cases, the assistance request 210 may request for the base station 105-a to transmit a UE discovery request signal (e.g., a UE discovery request 215) to one or more cooperative UEs (e.g., the UE 115-b and the UE 115-c). Stated alternatively, a target UE (e.g., the UE 115-a) may transmit an uplink signal to a base station (e.g., the base station 105-a) to request for assistance with UE discovery.

In response to receiving the assistance request 210, the base station 105-a may transmit a UE discovery request to one or more cooperative UEs. In some cases, the base station 105-a may determine one or more cooperative UEs based on information included in the assistance request 210. For instance, the UE 115-a may transmit information related to UE cooperation in the assistance request 210. For example, the assistance request 210 may include one or more indications for criteria which may be used by the base station 105-a for selecting cooperative UEs. In some cases, the one or more indications may include criteria associated with the cooperative link (e.g., sidelink) to be established with the target UE (e.g., the UE 115-a). Stated alternatively, the assistance request 210 may include information to be used for selecting cooperative UEs with suitable sidelink capabilities. For example, the one or more indications may indicate an expected sidelink type (e.g., Wi-Fi, Bluetooth, or an NR sidelink), an expected sidelink latency, or an expected quality of service (QOS) associated with a sidelink. The base station 105-a may selectively broadcast or unicast a UE discovery request signal associated with the UE 115-a to the UEs 115 that satisfy the criteria described herein, such as UEs 115 capable of supporting the expected QoS, sidelink latency, and sidelink type, although it is to be understood that any criteria or no criteria may be implemented. For example, the base station 105-a may broadcast the signal to multiple UEs regardless of criteria satisfying thresholds. Additionally or alternatively, the base station 105-a may include the criteria when transmitting the signal to other UEs 115, and the other UEs 115 may attempt to establish a cooperative line with the target UE 115 based on whether the criteria are satisfied. Further, while several examples of criteria or information included in the UE discovery request signals are described herein, any combination of such criteria and information or other examples of criteria and information may be implemented.

In some other cases, the one or more indications may include criteria associated with the cooperative UE (e.g., an expected capability of the cooperative UE). Stated alternatively, the assistance request 210 may include information to be used for selecting cooperative UEs with suitable UE capabilities (e.g., capabilities that satisfy one or more thresholds, which may additionally or alternatively be referred to as criteria). For example, the one or more indications may indicate an expected frequency or an expected transmit power (e.g., a frequency band or a transmit power associated with a direct link between the base station 105-a and the cooperative UE) to be supported by the cooperative UE. Additionally or alternatively, the one or more indications may include criteria associated with an area in which UE cooperation may be performed. Stated alternatively, the assistance request 210 may include information to be used for selecting cooperative UEs located in a suitable area. For example, the one or more indications may indicate a location of the target UE (e.g., the location of the UE 115-a), one or more expected locations for the cooperative UE, a UE ID associated with the cooperative UE, a cell ID associated with the cooperative UE, or a group ID associated with the cooperative UE.

In some examples, the base station 105-a may broadcast the UE discovery request 215 to the selected cooperative UEs (e.g., to potential cooperative UEs) via a direct link (e.g., a Uu link). In some cases, the base station 105-a may broadcast the UE discovery request 215 via a paging control channel (PCCH), via a system information (SI) message, or via a message transmitted using a dedicated broadcasting channel for UE cooperation. For example, the base station 105-a may broadcast the UE discovery request 215 to the UE 115-b via a direct link (e.g., the communication link 205-b). In response to receiving the UE discovery request 215, the UE 115-b may activate sidelink communications. In some cases, the UE 115-b may then transmit a sidelink signal (e.g., a cooperative link indication 220), via the communication link 205-c (e.g., via a sidelink), indicating that the UE 115-b may be available for UE cooperation (e.g., may be available to establish a cooperative link with the UE 115-a). In some cases, the UE 115-a and the UE 115-b may then establish a cooperative link based on the cooperative link indication 220. In some examples, the base station 105-a may receive, from the UE 115-a, an indication of the established cooperative link between the UE 115-a and the UE 115-b. In some cases, the base station 105-a may then transmit downlink communications to the UE 115-a via the direct link with the UE 115-a (e.g., the communication link 205-a) and the direct link with the UE 115-b (e.g., the communication link 205-b). For example, the UE 115-b may receive downlink information (e.g., a downlink communication 225-a) for the target UE (e.g., the UE 115-a) via the communication link 205-b. The UE 115-b may then relay the received information (e.g., transmit a downlink communication 225-b) to the UE 115-a via the established cooperative link (e.g., the communication link 205-c).

In some examples, the base station 105-a may select a set (e.g., group) of cooperative UEs based on information related to one or more operations request by the target UE (e.g., the UE 115-a). For example, the UE 115-a may request for a multi-TRP (M-TRP) operation. In such an example, the base station 105-a may select a group of cooperative UEs which may be served by a different TRP than may be serving the target UE (e.g., a group of UEs served by a base station other than the base station 105-a). In some cases, the base station 105-a may then transmit a UE discovery request to the selected group of cooperative UEs via the other TRP (not shown).

In another example, the UE 115-a may request for a MIMO operation. In such an example, the base station 105-a may select a group of cooperative UEs which may be served by a different beam than may be serving the target UE. In some cases, the base station 105-a may select a group of cooperative UEs such that the beam serving the group of cooperative UEs may be suitably separated from the beam serving the target UE (e.g., the UE 115-a). In some instances, the spatial separation between the beam serving the group of cooperative UEs and the beam serving the target UE may satisfy a threshold. In some cases, the base station 105-a may then transmit a UE discovery signal to the selected group of cooperative UEs via the other beam.

In yet another example, the UE 115-a may request for UE cooperation to occur (e.g., the cooperative link to be established) in an indicated location. In such an example, the base station 105-a may select a group of cooperative UEs associated with the indicated location for the cooperative link. For example, the base station 105-a may select the UE 115-b to transmit a UE discovery signal (e.g., forward the UE discovery signal from the UE 115-a to the UE 115-b via the communication link 205-b) based on the UE 115-b being within the indicated location, the UE 115-b having a UE ID, a cell ID, or UE group ID indicated by the UE 115-a, or an combination thereof. Additionally or alternatively, the base station 105-a may exclude the UE 115-c for communicating the UE discovery signal based on the UE 115-c being outside the indicated area or being associated with a different UE ID or UE group ID.

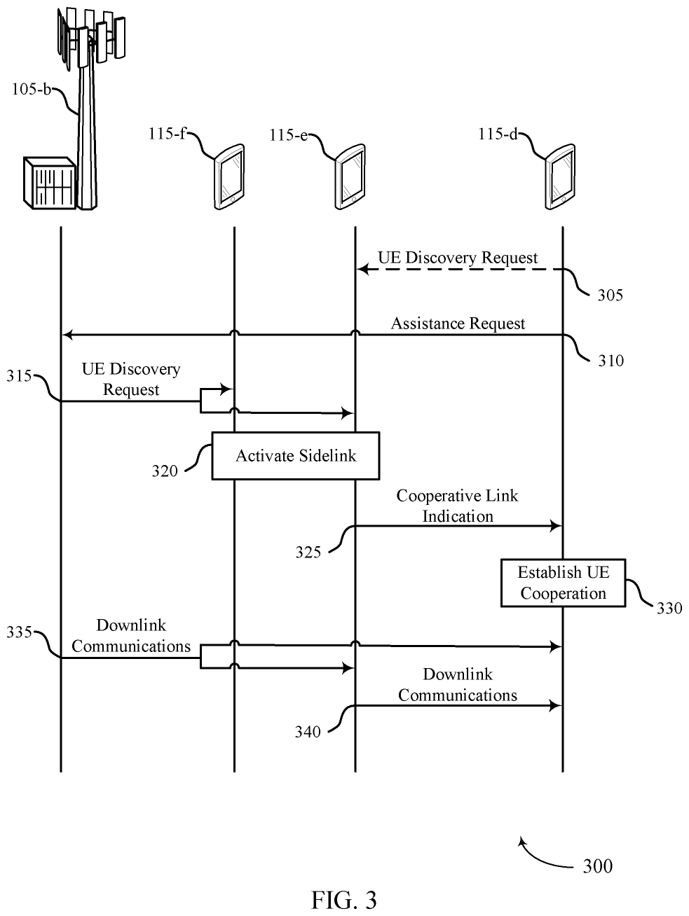

FIG. 3 illustrates an example of a process flow 300 that supports base station assistance for UE discovery in accordance with aspects of the present disclosure. In some examples, the process flow 300 may implement aspects of the wireless communications systems 100 and 200. For instance, the process flow 300 may include a base station 105-b, a UE 115-d, a UE 115-e, and a UE 115-f, which may each be examples of the corresponding devices described with reference to FIGS. 1 and 2. The process flow 300 may be implemented by the base station 105-b, one or more of the UEs 115, or a combination thereof. In the following description of the process flow 300, the information communicated between the base station 105-b and the UEs 115 may be performed in different orders or at different times. Some operations may also be omitted from the process flow 300, and other operations may be added to the process flow 300.

The process flow 300 may be implemented by the base station 105-b, the UEs 115, or a combination thereof. In the following description of the process flow 300, the information communicated between the base station 105-b and the UEs 115 may be performed in different orders or at different times. Some operations may also be omitted from the process flow 300, and other operations may be added to the process flow 300.

In some examples, at 305 the UE 115-d (e.g., the target UE) may transmit a sidelink UE discovery signal to the UE 115-e (e.g., a cooperative UE) to establish a cooperative link (e.g., for UE cooperation) with the UE 115-e. In some examples, the UE 115-d may transmit such discovery signals to multiple UEs 115 (e.g., the UE 115-d may broadcast the signal). The UE 115-d may monitor for one or more responses to the sidelink UE discovery request signal. If the UE 115-d receives a response that satisfies one or more thresholds (e.g., criteria), the UE 115-d may select a UE 115 associated with the response and establish a cooperative link. For example, the UE 115-d and the UE 115-e may exchange signaling to establish sidelink communication resource that the UE 115-e may use to forward communications from the base station 105-b to the UE 115-d, though any quantity of UEs 115 and cooperative links may be used. However, in some examples, the UE 115-d may fail to receive a response or the UE 115-d may determine that received responses fail to satisfy the one or more thresholds. In such examples, the UE 115-d may transmit an assistance request to the base station 105-b at 310. As an illustrative example, in the process flow 300 the UE 115-d may transmit an assistance request to the base station 105-b based on failing to receive the response to the sidelink UE discovery request signal transmitted over sidelink resources to other UEs 115. In some other examples, the UE 115-d may refrain from transmitting a UE discovery signal over sidelink communications and may instead initiate UE cooperation by transmitting the assistance request to the base station 105-b.

At 310, the UE 115-d may transmit an uplink signal (e.g., an assistance request) indicating a request for the base station to transmit a UE discovery request signal to at least a second UE (e.g., one or more cooperative UEs). The uplink signal may be an example of the uplink signal described with reference to FIG. 2. For example, the uplink signal may include or be an example of a UE discovery request. The uplink signal may include one or more sets of information (e.g., criteria or thresholds for the cooperative link or cooperative UE as described herein). For example, the uplink signal may indicate a first information set of information used for selecting cooperative UEs with a proper sidelink. In some cases, the first information set may include an expected sidelink type (e.g., Wi-Fi or NR sidelink), an expected latency, or an expected QoS of traffic. Additionally or alternatively, the uplink signal may indicate a second information set information used for selecting cooperative UEs with a threshold UE capability. In some cases, the second set of information may include an expected supported frequency band in an NR Uu link or an expected transmit power in an NR Uu link. Additionally or alternatively, the uplink signal may indicate a third information set of information used for selecting cooperative UEs in a threshold area. In some cases, the third information set may include a target UE location, an expected cooperative UE location, an expected UE ID, or an expected UE group ID.

At 315, based on receiving an assistance request, the base station 105-b may transmit a UE discovery request signal corresponding to the UE 115-d to one or more cooperative UEs (e.g., to the UE 115-e and the UE 115-f). The UE discovery request signal may be an example of the UE discovery request described with reference to FIG. 2. In some cases, the UE discovery request signal may be valid during a time period. In some examples, the time period may be pre-determined and, in some other examples, the time period may be indicated via signaling (e.g., the time period may be included or indicated in the UE discovery request signal or other signaling, such as control signaling). In some examples, based on receiving the UE discovery request signal, the one or more cooperative UEs may transmit a response to the base station 105-b. In some cases, the one or more cooperative UEs may transmit the response during the time period.

At 320, in response to receiving the UE discovery request signal from the base station 105-b, the UE 115-e (e.g., and the UE 115-f) may activate sidelink communications. In some cases, the UE 115-e and the UE 115-f may activate sidelink communications for a period of time (e.g., the sidelink communications may be activated for a time period, and upon expiration of the timer period, the sidelink communications may be deactivated, for example, if a respective UE 115 did not establish a cooperative link). As an illustrative example, the UE 115-e may activate the sidelink communications to initiate the establishment of a cooperative link with the UE 115-d or to monitor for future UE discovery request signals from the UE 115-d. In some examples, the UE 115-e may maintain an RRC idle state while activating the sidelink communications, or the UE 115-e may exit the idle mode of operation. Then, at 325, the UE 115-e may transmit a sidelink signal to the UE 115-d indicating that the UE 115-e may be available to establish a cooperative link with the UE 115-d. The sidelink signal may be an example of the cooperative link indication described with reference to FIG. 2.

At 330, the UE 115-d may, in response to receiving the cooperative link indication from the UE 115-e, establish the cooperative link with the UE 115-e. In some examples, the base station 105-b may receive an indication of the cooperative link established between the UE 115-d and the UE 115-e. The cooperative link may be an example of the cooperative link described with reference to FIG. 2.

At 335, the base station 105-b may transmit downlink communications for the UE 115-d to the UE 115-d (e.g., via a direct link with the UE 115-d) and to the UE 115-e (e.g., via a direct link with the UE 115-e). In such cases, the UE 115-e may transmit (e.g., forward) the downlink communications to the UE 115-d via the established cooperative link. For example, at 340, the UE 115-e may transmit, to the UE 115-d, sidelink communications which may correspond to the downlink communications received from the base station 105-b. The downlink communications may be an example of the downlink communications described with reference to FIG. 2.

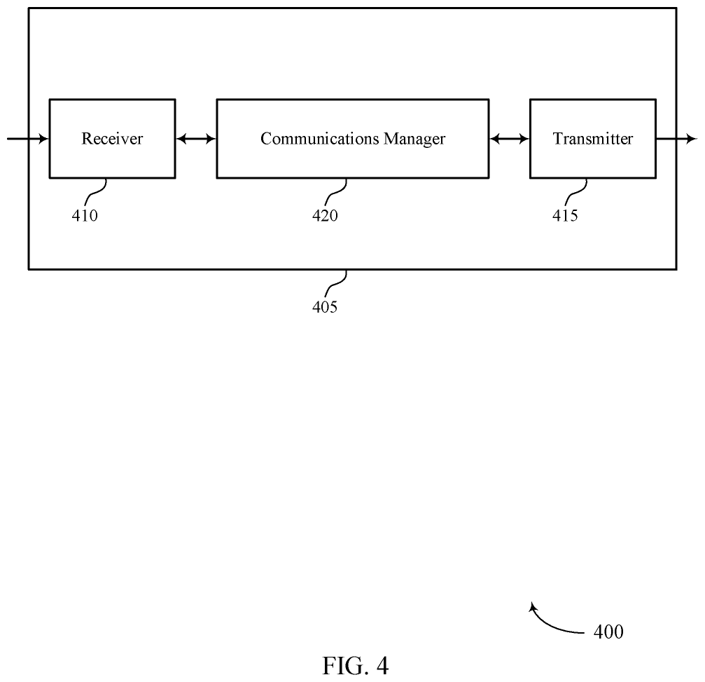

FIG. 4 shows a block diagram 400 of a device 405 that supports base station assistance for UE discovery in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to base station assistance for UE discovery). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to base station assistance for UE discovery). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of base station assistance for UE discovery as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a first UE in accordance with examples as disclosed herein. For example, the communications manager 420 may be configured as or otherwise support a means for transmitting, to a base station, an uplink signal indicating a request for the base station to transmit a UE discovery request signal to at least a second UE. The communications manager 420 may be configured as or otherwise support a means for receiving, from the second UE, a sidelink signal based on transmitting the uplink signal, the sidelink signal indicating that the second UE is available for a cooperative link with the first UE. The communications manager 420 may be configured as or otherwise support a means for establishing the cooperative link with the second UE based on receiving the sidelink signal. The communications manager 420 may be configured as or otherwise support a means for receiving downlink communications from the base station via at least sidelink communications from the second UE over the cooperative link based on establishing the cooperative link with the second UE.

Additionally or alternatively, the communications manager 420 may support wireless communications at a second UE in accordance with examples as disclosed herein. For example, the communications manager 420 may be configured as or otherwise support a means for receiving, from a base station and while operating in an idle mode, a UE discovery request signal corresponding to a first UE. The communications manager 420 may be configured as or otherwise support a means for transmitting, to the first UE, a sidelink signal based on receiving the UE discovery request signal from the base station, the sidelink signal indicating that the second UE is available for a cooperative link with the first UE. The communications manager 420 may be configured as or otherwise support a means for establishing the cooperative link with the first UE based on transmitting the sidelink signal. The communications manager 420 may be configured as or otherwise support a means for receiving downlink communications from the base station via a direct link with the base station. The communications manager 420 may be configured as or otherwise support a means for transmitting sidelink communications to the first UE via the cooperative link, the sidelink communications corresponding to the downlink communications received from the base station.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for base station assisted UE discovery. For example, the device 405 may establish a cooperative link based on base station assistance as described herein, which may result in more efficient utilization of resources in the system, improved communication throughput or reliability, or any combination thereof, among other examples of advantages.

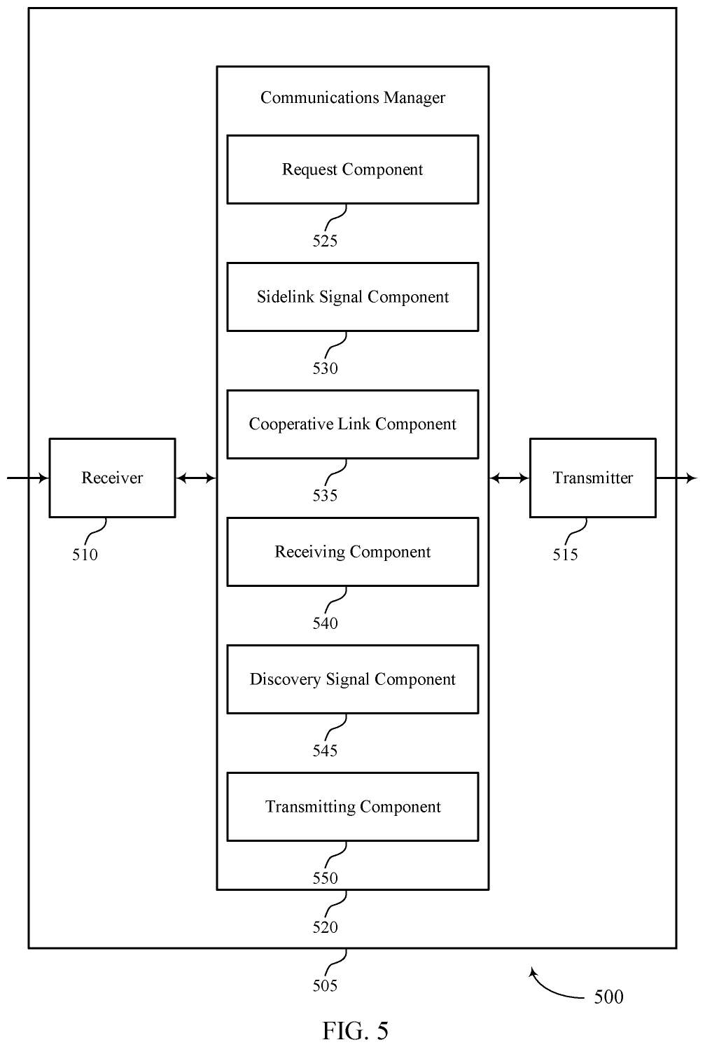

FIG. 5 shows a block diagram 500 of a device 505 that supports base station assistance for UE discovery in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to base station assistance for UE discovery). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to base station assistance for UE discovery). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of base station assistance for UE discovery as described herein. For example, the communications manager 520 may include a request component 525, a sidelink signal component 530, a cooperative link component 535, a receiving component 540, a discovery signal component 545, a transmitting component 550, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. The request component 525 may be configured as or otherwise support a means for transmitting, to a base station, an uplink signal indicating a request for the base station to transmit a UE discovery request signal to at least a second UE. The sidelink signal component 530 may be configured as or otherwise support a means for receiving, from the second UE, a sidelink signal based on transmitting the uplink signal, the sidelink signal indicating that the second UE is available for a cooperative link with the first UE. The cooperative link component 535 may be configured as or otherwise support a means for establishing the cooperative link with the second UE based on receiving the sidelink signal. The receiving component 540 may be configured as or otherwise support a means for receiving downlink communications from the base station via at least sidelink communications from the second UE over the cooperative link based on establishing the cooperative link with the second UE.

Additionally or alternatively, the communications manager 520 may support wireless communications at a second UE in accordance with examples as disclosed herein. The discovery signal component 545 may be configured as or otherwise support a means for receiving, from a base station and while operating in an idle mode, a UE discovery request signal corresponding to a first UE. The sidelink signal component 530 may be configured as or otherwise support a means for transmitting, to the first UE, a sidelink signal based on receiving the UE discovery request signal from the base station, the sidelink signal indicating that the second UE is available for a cooperative link with the first UE. The cooperative link component 535 may be configured as or otherwise support a means for establishing the cooperative link with the first UE based on transmitting the sidelink signal. The receiving component 540 may be configured as or otherwise support a means for receiving downlink communications from the base station via a direct link with the base station. The transmitting component 550 may be configured as or otherwise support a means for transmitting sidelink communications to the first UE via the cooperative link, the sidelink communications corresponding to the downlink communications received from the base station.

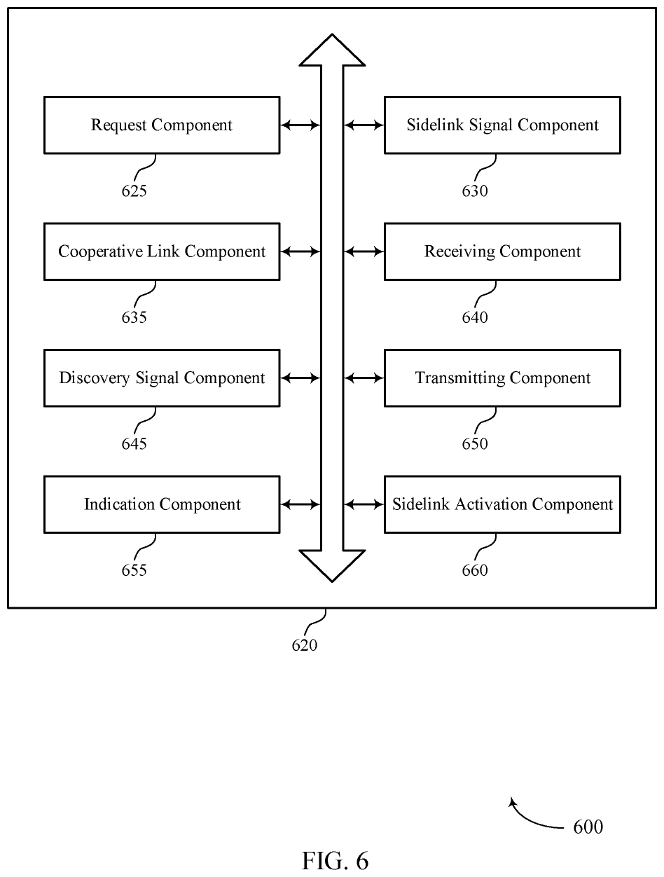

FIG. 6 shows a block diagram 600 of a communications manager 620 that supports base station assistance for UE discovery in accordance with aspects of the present disclosure. The communications manager 620 may be an example of aspects of a communications manager 420, a communications manager 520, or both, as described herein. The communications manager 620, or various components thereof, may be an example of means for performing various aspects of base station assistance for UE discovery as described herein. For example, the communications manager 620 may include a request component 625, a sidelink signal component 630, a cooperative link component 635, a receiving component 640, a discovery signal component 645, a transmitting component 650, an indication component 655, a sidelink activation component 660, or any combination thereof. Each of these components may communicate, directly or indirectly, with one another (e.g., via one or more buses).

The communications manager 620 may support wireless communications at a first UE in accordance with examples as disclosed herein. The request component 625 may be configured as or otherwise support a means for transmitting, to a base station, an uplink signal indicating a request for the base station to transmit a UE discovery request signal to at least a second UE. The sidelink signal component 630 may be configured as or otherwise support a means for receiving, from the second UE, a sidelink signal based on transmitting the uplink signal, the sidelink signal indicating that the second UE is available for a cooperative link with the first UE. The cooperative link component 635 may be configured as or otherwise support a means for establishing the cooperative link with the second UE based on receiving the sidelink signal. The receiving component 640 may be configured as or otherwise support a means for receiving downlink communications from the base station via at least sidelink communications from the second UE over the cooperative link based on establishing the cooperative link with the second UE.

In some examples, the indication component 655 may be configured as or otherwise support a means for transmitting, to the base station, one or more indications each corresponding to a respective criterion for the cooperative link associated with the UE discovery request signal.

In some examples, the one or more indications include an indication of a sidelink type for the cooperative link, an indication of a latency for the cooperative link, an indication of a quality of service associated with the cooperative link, or any combination thereof.

In some examples, the indication component 655 may be configured as or otherwise support a means for transmitting, to the base station, one or more indications each corresponding to a respective criterion for the second UE.

In some examples, the one or more indications include an indication of a frequency band associated with a second direct link associated with the second UE, an indication of a transmit power associated with the second direct link, or any combination thereof.

In some examples, the indication component 655 may be configured as or otherwise support a means for transmitting, to the base station, an indication of a location of the first UE, an indication of one or more locations associated with the cooperative link, an indication of the second UE, an indication of a group of UEs including the second UE, or any combination thereof.

In some examples, the discovery signal component 645 may be configured as or otherwise support a means for transmitting, to at least the second UE prior to transmitting the uplink signal, a sidelink UE discovery request signal to establish the cooperative link. In some examples, the discovery signal component 645 may be configured as or otherwise support a means for monitoring for a response to the sidelink UE discovery request signal, where transmitting the uplink signal to the base station is based on failing to receive the response to the sidelink UE discovery request signal.

Additionally or alternatively, the communications manager 620 may support wireless communications at a second UE in accordance with examples as disclosed herein. The discovery signal component 645 may be configured as or otherwise support a means for receiving, from a base station and while operating in an idle mode, a UE discovery request signal corresponding to a first UE. In some examples, the sidelink signal component 630 may be configured as or otherwise support a means for transmitting, to the first UE, a sidelink signal based on receiving the UE discovery request signal from the base station, the sidelink signal indicating that the second UE is available for a cooperative link with the first UE. In some examples, the cooperative link component 635 may be configured as or otherwise support a means for establishing the cooperative link with the first UE based on transmitting the sidelink signal. In some examples, the receiving component 640 may be configured as or otherwise support a means for receiving downlink communications from the base station via a direct link with the base station. The transmitting component 650 may be configured as or otherwise support a means for transmitting sidelink communications to the first UE via the cooperative link, the sidelink communications corresponding to the downlink communications received from the base station.

In some examples, the discovery signal component 645 may be configured as or otherwise support a means for receiving the UE discovery request signal from the base station via a broadcast message.

In some examples, the broadcast message includes a paging channel message, a system information message, a message communicated over a broadcast channel corresponding to UE cooperation, or any combination thereof.

In some examples, the sidelink activating component 660 may be configured as or otherwise support a means for activating sidelink communications at the second UE in response to receiving the UE discovery request signal from the base station, where transmitting the sidelink signal is based on activating the sidelink communications.

In some examples, the indication component 655 may be configured as or otherwise support a means for receiving one or more indications each corresponding to a respective criterion for the cooperative link associated with the UE discovery request signal, a respective criterion for the second UE, or any combination thereof.

In some examples, the one or more indications include an indication of a sidelink type for the cooperative link, an indication of a latency for the cooperative link, an indication of a quality of service associated with the cooperative link, an indication of a frequency band associated with the direct link, an indication of a transmit power associated with the direct link, an indication of a location of the first UE, an indication of one or more locations associated with the cooperative link, an indication of the second UE, an indication of a group of UEs including the second UE, or any combination thereof.

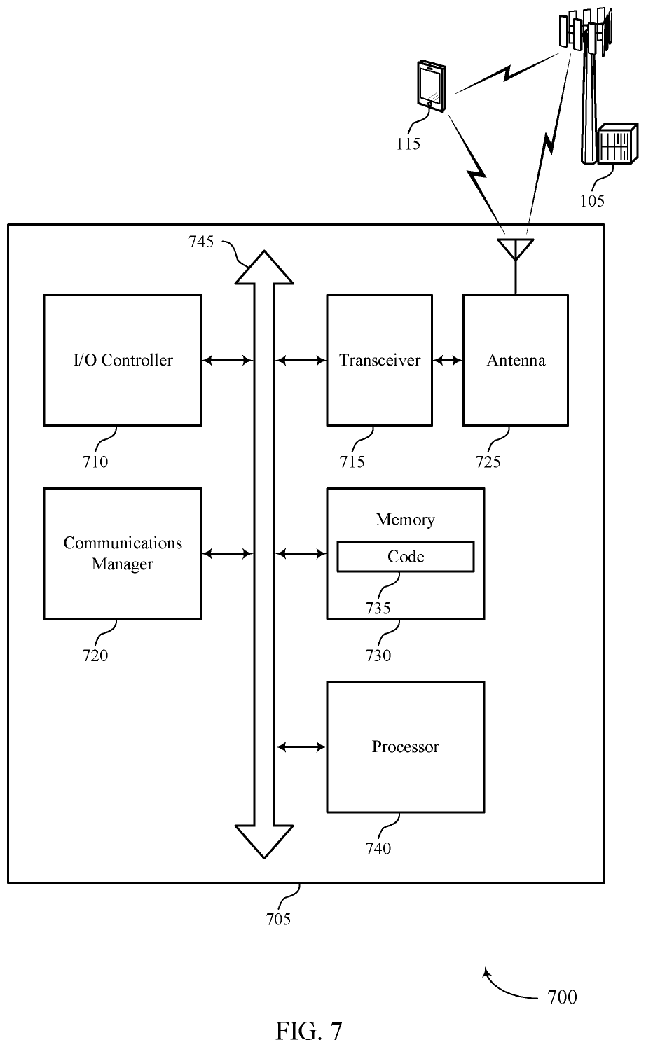

FIG. 7 shows a diagram of a system 700 including a device 705 that supports base station assistance for UE discovery in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting base station assistance for UE discovery). For example, the device 705 or a component of the device 705 may include a processor 740 and memory 730 coupled to the processor 740, the processor 740 and memory 730 configured to perform various functions described herein.

The communications manager 720 may support wireless communications at a first UE in accordance with examples as disclosed herein. For example, the communications manager 720 may be configured as or otherwise support a means for transmitting, to a base station, an uplink signal indicating a request for the base station to transmit a UE discovery request signal to at least a second UE. The communications manager 720 may be configured as or otherwise support a means for receiving, from the second UE, a sidelink signal based on transmitting the uplink signal, the sidelink signal indicating that the second UE is available for a cooperative link with the first UE. The communications manager 720 may be configured as or otherwise support a means for establishing the cooperative link with the second UE based on receiving the sidelink signal. The communications manager 720 may be configured as or otherwise support a means for receiving downlink communications from the base station via at least sidelink communications from the second UE over the cooperative link based on establishing the cooperative link with the second UE.

Additionally or alternatively, the communications manager 720 may support wireless communications at a second UE in accordance with examples as disclosed herein. For example, the communications manager 720 may be configured as or otherwise support a means for receiving, from a base station and while operating in an idle mode, a UE discovery request signal corresponding to a first UE. The communications manager 720 may be configured as or otherwise support a means for transmitting, to the first UE, a sidelink signal based on receiving the UE discovery request signal from the base station, the sidelink signal indicating that the second UE is available for a cooperative link with the first UE. The communications manager 720 may be configured as or otherwise support a means for establishing the cooperative link with the first UE based on transmitting the sidelink signal. The communications manager 720 may be configured as or otherwise support a means for receiving downlink communications from the base station via a direct link with the base station. The communications manager 720 may be configured as or otherwise support a means for transmitting sidelink communications to the first UE via the cooperative link, the sidelink communications corresponding to the downlink communications received from the base station.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of base station assistance for UE discovery as described herein, or the processor 740 and the memory 730 may be otherwise configured to perform or support such operations.

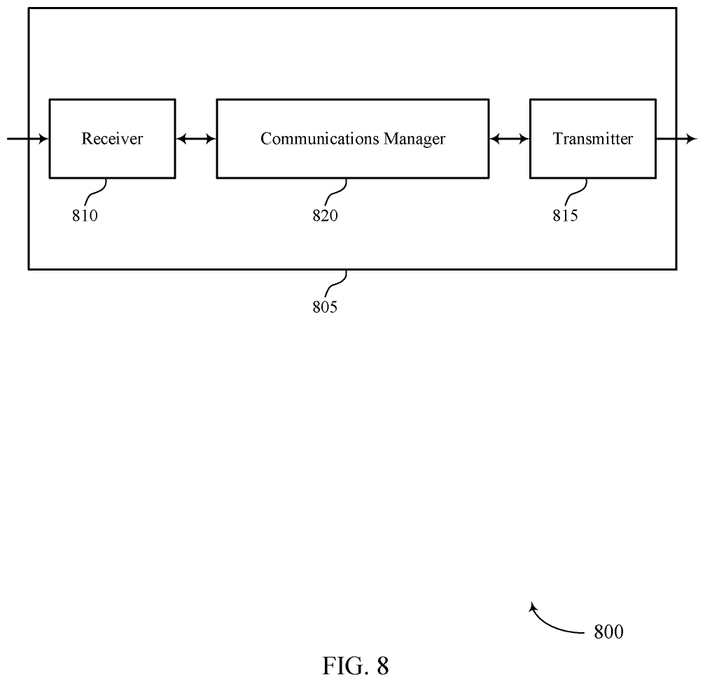

FIG. 8 shows a block diagram 800 of a device 805 that supports base station assistance for UE discovery in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to base station assistance for UE discovery). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to base station assistance for UE discovery). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of base station assistance for UE discovery as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a base station in accordance with examples as disclosed herein. For example, the communications manager 820 may be configured as or otherwise support a means for receiving, from a first UE, an uplink signal indicating a request for the base station to transmit a UE discovery request signal to at least a second UE. The communications manager 820 may be configured as or otherwise support a means for transmitting, to at least the second UE and based on receiving the uplink signal, the UE discovery request signal corresponding to the first UE. The communications manager 820 may be configured as or otherwise support a means for receiving, from at least one of the first UE or the second UE, an indication of a cooperative link between the first UE and the second UE based on transmitting the UE discovery request signal. The communications manager 820 may be configured as or otherwise support a means for transmitting, to the first UE and the second UE, downlink communications for the first UE via a first direct link with the first UE and a second direct link with the second UE.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources.

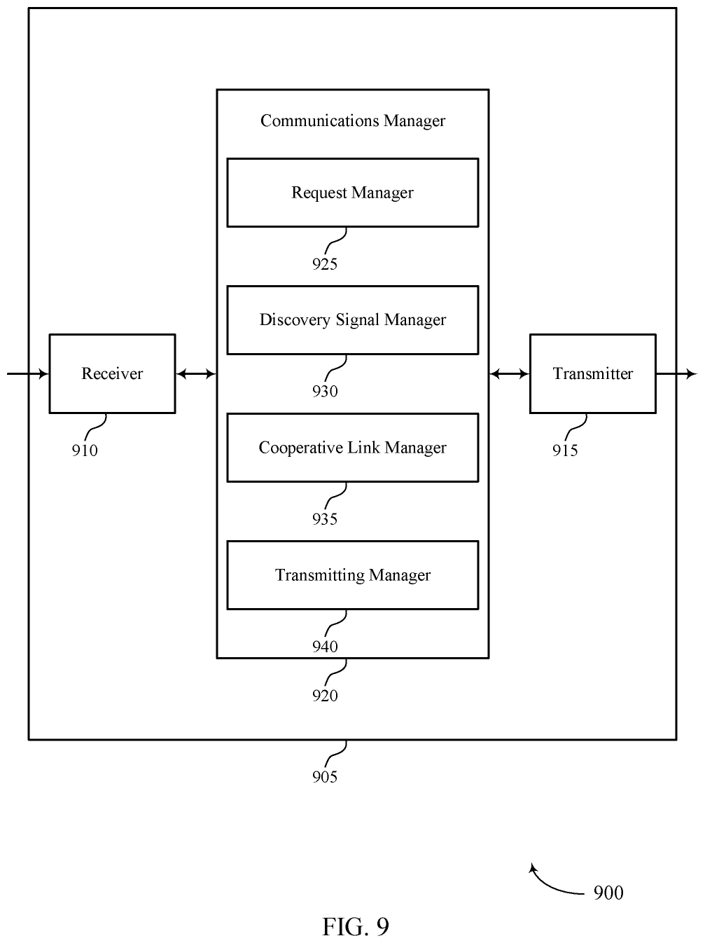

FIG. 9 shows a block diagram 900 of a device 905 that supports base station assistance for UE discovery in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to base station assistance for UE discovery). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to base station assistance for UE discovery). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of base station assistance for UE discovery as described herein. For example, the communications manager 920 may include a request manager 925, a discovery signal manager 930, a cooperative link manager 935, a transmitting manager 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. The request manager 925 may be configured as or otherwise support a means for receiving, from a first UE, an uplink signal indicating a request for the base station to transmit a UE discovery request signal to at least a second UE. The discovery signal manager 930 may be configured as or otherwise support a means for transmitting, to at least the second UE and based on receiving the uplink signal, the UE discovery request signal corresponding to the first UE. The cooperative link manager 935 may be configured as or otherwise support a means for receiving, from at least one of the first UE or the second UE, an indication of a cooperative link between the first UE and the second UE based on transmitting the UE discovery request signal. The transmitting manager 940 may be configured as or otherwise support a means for transmitting, to the first UE and the second UE, downlink communications for the first UE via a first direct link with the first UE and a second direct link with the second UE.

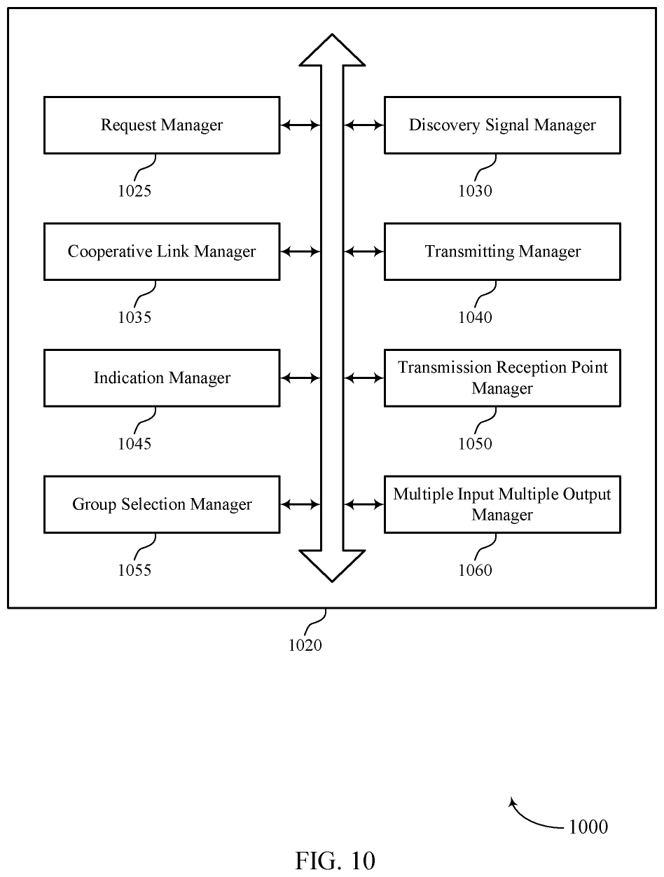

FIG. 10 shows a block diagram 1000 of a communications manager 1020 that supports base station assistance for UE discovery in accordance with aspects of the present disclosure. The communications manager 1020 may be an example of aspects of a communications manager 820, a communications manager 920, or both, as described herein. The communications manager 1020, or various components thereof, may be an example of means for performing various aspects of base station assistance for UE discovery as described herein. For example, the communications manager 1020 may include a request manager 1025, a discovery signal manager 1030, a cooperative link manager 1035, a transmitting manager 1040, an indication manager 1045, a transmission reception point manager 1050, a group selection manager 1055, a multiple input multiple output manager 1060, or any combination thereof. Each of these components may communicate, directly or indirectly, with one another (e.g., via one or more buses).

The communications manager 1020 may support wireless communications at a base station in accordance with examples as disclosed herein. The request manager 1025 may be configured as or otherwise support a means for receiving, from a first UE, an uplink signal indicating a request for the base station to transmit a UE discovery request signal to at least a second UE. The discovery signal manager 1030 may be configured as or otherwise support a means for transmitting, to at least the second UE and based on receiving the uplink signal, the UE discovery request signal corresponding to the first UE. The cooperative link manager 1035 may be configured as or otherwise support a means for receiving, from at least one of the first UE or the second UE, an indication of a cooperative link between the first UE and the second UE based on transmitting the UE discovery request signal. The transmitting manager 1040 may be configured as or otherwise support a means for transmitting, to the first UE and the second UE, downlink communications for the first UE via a first direct link with the first UE and a second direct link with the second UE.

In some examples, the indication manager 1045 may be configured as or otherwise support a means for receiving, from the first UE, one or more indications each corresponding to a respective criterion for the cooperative link associated with the UE discovery request signal. In some examples, the one or more indications include an indication of a sidelink type for the cooperative link, an indication of a latency for the cooperative link, an indication of a quality of service associated with the cooperative link, or any combination thereof.

In some examples, the indication manager 1045 may be configured as or otherwise support a means for receiving, from the first UE, one or more indications each corresponding to a respective criterion for the second UE. In some examples, the one or more indications include an indication of a frequency band associated with the second direct link, an indication of a transmit power associated with the second direct link, or any combination thereof. In some examples, the indication manager 1045 may be configured as or otherwise support a means for receiving, from at least the second UE, a capability message indicating a capability of the second UE, where transmitting the UE discovery request signal to the second UE is based on the capability of the second UE satisfying the respective criterion for the second UE.

In some examples, the indication manager 1045 may be configured as or otherwise support a means for receiving one or more indications from the first UE, the one or more indications including an indication of a location of the first UE, an indication of one or more locations associated with the cooperative link, an indication of the second UE, an indication of a group of UEs including the second UE, or any combination thereof, where transmitting the UE discovery request signal is based on receiving the one or more indications.

In some examples, the indication manager 1045 may be configured as or otherwise support a means for transmitting, to at least the second UE, one or more indications each corresponding to a respective criterion for the cooperative link associated with the UE discovery request signal, a respective criterion for the second UE, or any combination thereof.

In some examples, the one or more indications include an indication of a sidelink type for the cooperative link, an indication of a latency for the cooperative link, an indication of a quality of service associated with the cooperative link, an indication of a frequency band associated with the second direct link, an indication of a transmit power associated with the second direct link, an indication of a location of the first UE, an indication of one or more locations associated with the cooperative link, an indication of the second UE, an indication of a group of UEs including the second UE, or any combination thereof.

In some examples, the discovery signal manager 1030 may be configured as or otherwise support a means for transmitting the UE discovery request signal to at least the second UE via a broadcast message.

In some examples, the broadcast message includes a paging channel message, a system information message, a message communicated over a broadcast channel corresponding to UE cooperation, or any combination thereof.

In some examples, the transmission reception point manager 1050 may be configured as or otherwise support a means for receiving, from the first UE, a request for multiple transmission reception point operation. In some examples, the group selection manager 1055 may be configured as or otherwise support a means for selecting, based on receiving the request for multiple transmission reception point operation, a group of UEs based on each UE in the group of UEs being served by a first transmission reception point different than a second transmission reception point serving the first UE. In some examples, the discovery signal manager 1030 may be configured as or otherwise support a means for transmitting the UE discovery request signal to the selected group of UEs, the selected group of UEs including the second UE.

In some examples, to support transmitting the downlink communications, the transmitting manager 1040 may be configured as or otherwise support a means for transmitting the downlink communications via the first direct link associated with the second transmission reception point and via the second direct link associated with the first transmission reception point.

In some examples, the multiple input multiple output manager 1060 may be configured as or otherwise support a means for receiving, from the first UE, a request for multiple user multiple input multiple output operation. In some examples, the group selection manager 1055 may be configured as or otherwise support a means for selecting, based on receiving the request for multiple user multiple input multiple output operation, a group of UEs based on each UE in the group of UEs being served by a first beam different than a second beam serving the first UE, where a spatial separation between the first beam and the second beam satisfies a threshold. In some examples, the discovery signal manager 1030 may be configured as or otherwise support a means for transmitting the UE discovery request signal to the selected group of UEs, the selected group of UEs including the second UE.

In some examples, to support transmitting the downlink communications, the transmitting manager 1040 may be configured as or otherwise support a means for transmitting the downlink communications via the first direct link associated with the second beam and via the second direct link associated with the first beam.

In some examples, the group selection manager 1055 may be configured as or otherwise support a means for selecting a group of UEs based on each UE in the group of UEs being associated with a location for the cooperative link, a UE group identifier associated with the cooperative link, a UE identifier associated with the cooperative link, or any combination thereof. In some examples, the discovery signal manager 1030 may be configured as or otherwise support a means for transmitting the UE discovery request signal to the selected group of UEs, the selected group of UEs including the second UE.

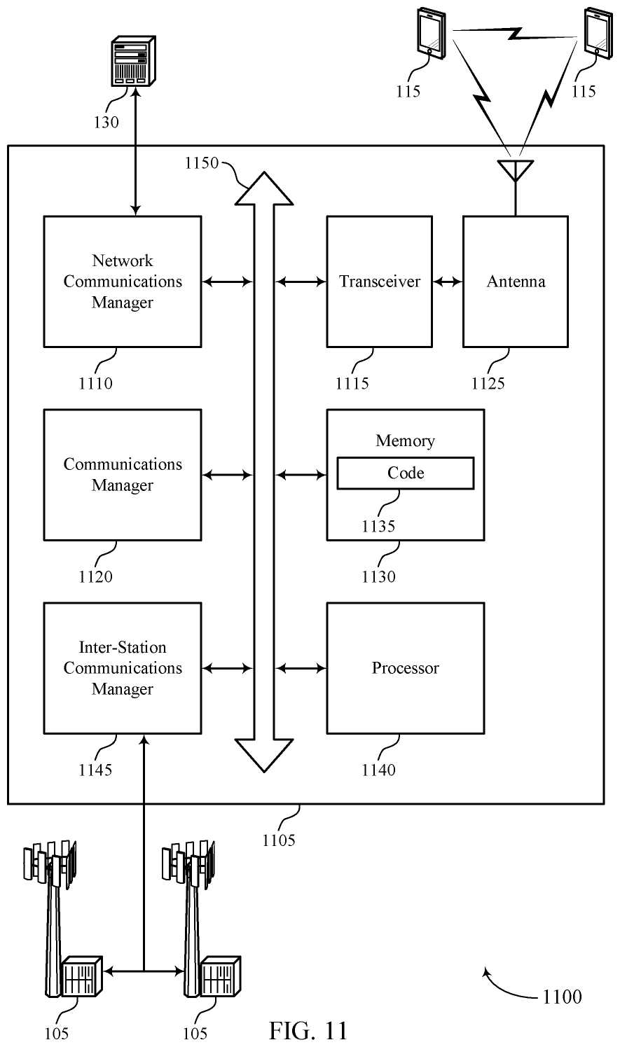

FIG. 11 shows a diagram of a system 1100 including a device 1105 that supports base station assistance for UE discovery in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting base station assistance for UE discovery). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at a base station in accordance with examples as disclosed herein. For example, the communications manager 1120 may be configured as or otherwise support a means for receiving, from a first UE, an uplink signal indicating a request for the base station to transmit a UE discovery request signal to at least a second UE. The communications manager 1120 may be configured as or otherwise support a means for transmitting, to at least the second UE and based on receiving the uplink signal, the UE discovery request signal corresponding to the first UE. The communications manager 1120 may be configured as or otherwise support a means for receiving, from at least one of the first UE or the second UE, an indication of a cooperative link between the first UE and the second UE based on transmitting the UE discovery request signal. The communications manager 1120 may be configured as or otherwise support a means for transmitting, to the first UE and the second UE, downlink communications for the first UE via a first direct link with the first UE and a second direct link with the second UE.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of base station assistance for UE discovery as described herein, or the processor 1140 and the memory 1130 may be otherwise configured to perform or support such operations.

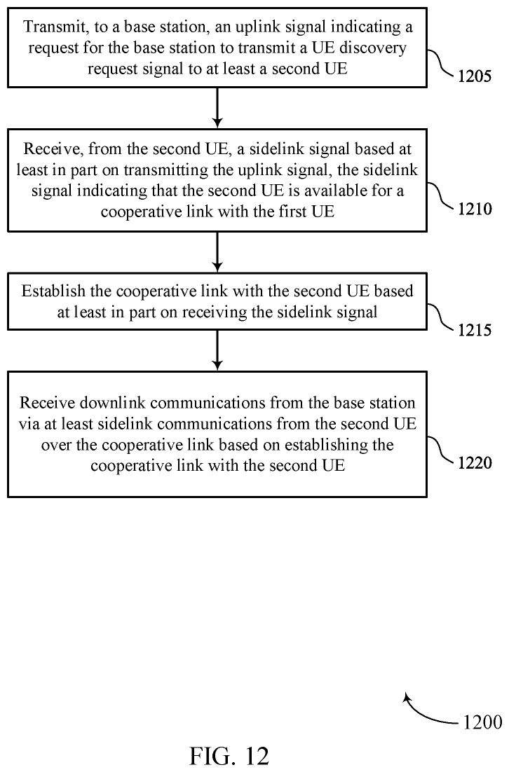

FIG. 12 shows a flowchart illustrating a method 1200 that supports base station assistance for UE discovery in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions.

Additionally or alternatively, the UE may perform aspects of the described functions using special-purpose hardware.

At 1205, the method may include transmitting, to a base station, an uplink signal indicating a request for the base station to transmit a UE discovery request signal to at least a second UE. The operations of 1205 may be performed in accordance with examples as disclosed herein. In some examples, aspects of the operations of 1205 may be performed by a request component 625 as described with reference to FIG. 6.

At 1210, the method may include receiving, from the second UE, a sidelink signal based on transmitting the uplink signal, the sidelink signal indicating that the second UE is available for a cooperative link with the first UE. The operations of 1210 may be performed in accordance with examples as disclosed herein. In some examples, aspects of the operations of 1210 may be performed by a sidelink signal component 630 as described with reference to FIG. 6.

At 1215, the method may include establishing the cooperative link with the second UE based on receiving the sidelink signal. The operations of 1215 may be performed in accordance with examples as disclosed herein. In some examples, aspects of the operations of 1215 may be performed by a cooperative link component 635 as described with reference to FIG. 6.

At 1220, the method may include receiving downlink communications from the base station via at least sidelink communications from the second UE over the cooperative link based on establishing the cooperative link with the second UE. The operations of 1220 may be performed in accordance with examples as disclosed herein. In some examples, aspects of the operations of 1220 may be performed by a receiving component 640 as described with reference to FIG. 6.

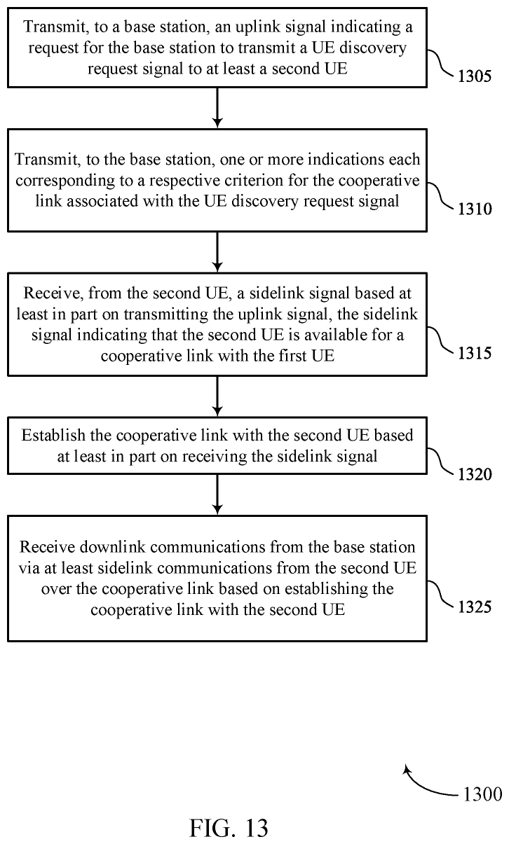

FIG. 13 shows a flowchart illustrating a method 1300 that supports base station assistance for UE discovery in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions.

Additionally or alternatively, the UE may perform aspects of the described functions using special-purpose hardware.

At 1305, the method may include transmitting, to a base station, an uplink signal indicating a request for the base station to transmit a UE discovery request signal to at least a second UE. The operations of 1305 may be performed in accordance with examples as disclosed herein. In some examples, aspects of the operations of 1305 may be performed by a request component 625 as described with reference to FIG. 6.

At 1310, the method may include transmitting, to the base station, one or more indications each corresponding to a respective criterion for the cooperative link associated with the UE discovery request signal. The operations of 1310 may be performed in accordance with examples as disclosed herein. In some examples, aspects of the operations of 1310 may be performed by an indication component 655 as described with reference to FIG. 6.

At 1315, the method may include receiving, from the second UE, a sidelink signal based on transmitting the uplink signal, the sidelink signal indicating that the second UE is available for a cooperative link with the first UE. The operations of 1315 may be performed in accordance with examples as disclosed herein. In some examples, aspects of the operations of 1315 may be performed by a sidelink signal component 630 as described with reference to FIG. 6.

At 1320, the method may include establishing the cooperative link with the second UE based on receiving the sidelink signal. The operations of 1320 may be performed in accordance with examples as disclosed herein. In some examples, aspects of the operations of 1320 may be performed by a cooperative link component 635 as described with reference to FIG. 6.

At 1325, the method may include receiving downlink communications from the base station via at least sidelink communications from the second UE over the cooperative link based on establishing the cooperative link with the second UE. The operations of 1325 may be performed in accordance with examples as disclosed herein. In some examples, aspects of the operations of 1325 may be performed by a receiving component 640 as described with reference to FIG. 6.

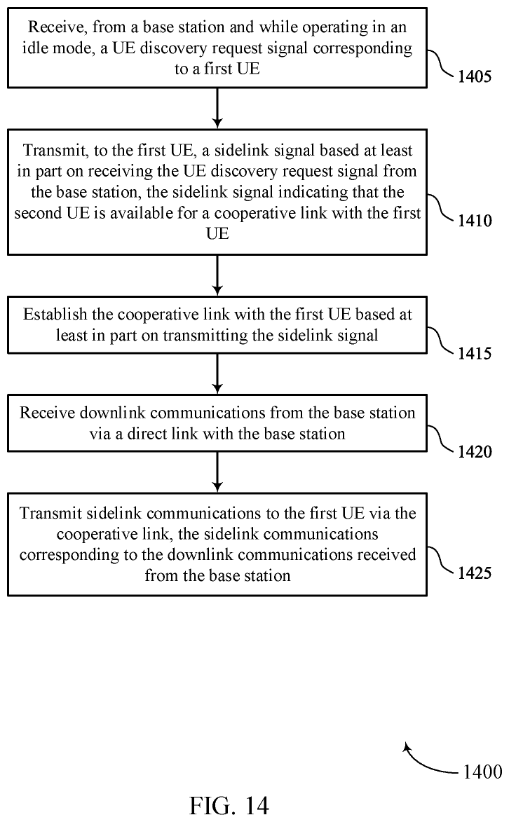

FIG. 14 shows a flowchart illustrating a method 1400 that supports base station assistance for UE discovery in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving, from a base station and while operating in an idle mode, a UE discovery request signal corresponding to a first UE. The operations of 1405 may be performed in accordance with examples as disclosed herein. In some examples, aspects of the operations of 1405 may be performed by a discovery signal component 645 as described with reference to FIG. 6.

At 1410, the method may include transmitting, to the first UE, a sidelink signal based on receiving the UE discovery request signal from the base station, the sidelink signal indicating that the second UE is available for a cooperative link with the first UE. The operations of 1410 may be performed in accordance with examples as disclosed herein. In some examples, aspects of the operations of 1410 may be performed by a sidelink signal component 630 as described with reference to FIG. 6.

At 1415, the method may include establishing the cooperative link with the first UE based on transmitting the sidelink signal. The operations of 1415 may be performed in accordance with examples as disclosed herein. In some examples, aspects of the operations of 1415 may be performed by a cooperative link component 635 as described with reference to FIG. 6.

At 1420, the method may include receiving downlink communications from the base station via a direct link with the base station. The operations of 1420 may be performed in accordance with examples as disclosed herein. In some examples, aspects of the operations of 1420 may be performed by a receiving component 640 as described with reference to FIG. 6.

At 1425, the method may include transmitting sidelink communications to the first UE via the cooperative link, the sidelink communications corresponding to the downlink communications received from the base station. The operations of 1425 may be performed in accordance with examples as disclosed herein. In some examples, aspects of the operations of 1425 may be performed by a transmitting component 650 as described with reference to FIG. 6.

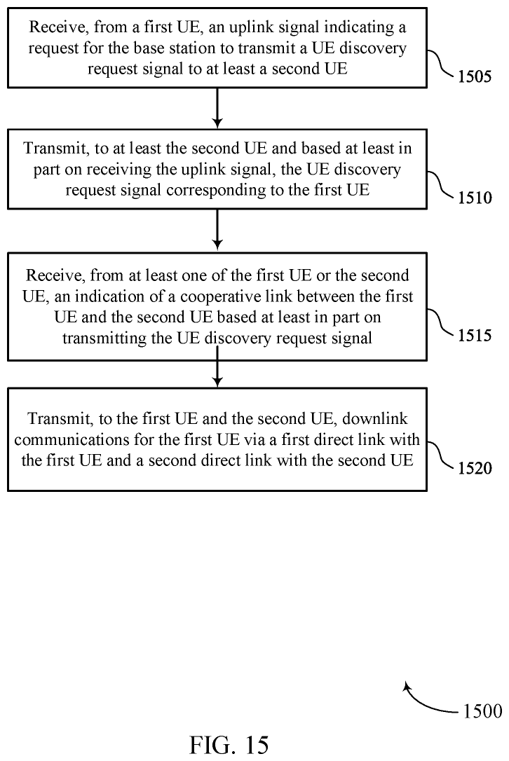

FIG. 15 shows a flowchart illustrating a method 1500 that supports base station assistance for UE discovery in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include receiving, from a first UE, an uplink signal indicating a request for the base station to transmit a UE discovery request signal to at least a second UE. The operations of 1505 may be performed in accordance with examples as disclosed herein. In some examples, aspects of the operations of 1505 may be performed by a request manager 1025 as described with reference to FIG. 10.

At 1510, the method may include transmitting, to at least the second UE and based on receiving the uplink signal, the UE discovery request signal corresponding to the first UE. The operations of 1510 may be performed in accordance with examples as disclosed herein. In some examples, aspects of the operations of 1510 may be performed by a discovery signal manager 1030 as described with reference to FIG. 10.

At 1515, the method may include receiving, from at least one of the first UE or the second UE, an indication of a cooperative link between the first UE and the second UE based on transmitting the UE discovery request signal. The operations of 1515 may be performed in accordance with examples as disclosed herein. In some examples, aspects of the operations of 1515 may be performed by a cooperative link manager 1035 as described with reference to FIG. 10.

At 1520, the method may include transmitting, to the first UE and the second UE, downlink communications for the first UE via a first direct link with the first UE and a second direct link with the second UE. The operations of 1520 may be performed in accordance with examples as disclosed herein. In some examples, aspects of the operations of 1520 may be performed by a transmitting manager 1040 as described with reference to FIG. 10.

The following provides an overview of aspects of the present disclosure:
Aspect 1: A method for wireless communications at a first UE, comprising: transmitting, to a base station, an uplink signal indicating a request for the base station to transmit a UE discovery request signal to at least a second UE; receiving, from the second UE, a sidelink signal based at least in part on transmitting the uplink signal, the sidelink signal indicating that the second UE is available for a cooperative link with the first UE; establishing the cooperative link with the second UE based at least in part on receiving the sidelink signal; and receiving downlink communications from the base station via at least sidelink communications from the second UE over the cooperative link based at least in part on establishing the cooperative link with the second UE.
Aspect 2: The method of aspect 1, further comprising: transmitting, to the base station, one or more indications each corresponding to a respective criterion for the cooperative link associated with the UE discovery request signal.
Aspect 3: The method of aspect 2, wherein the one or more indications comprise an indication of a sidelink type for the cooperative link, an indication of a latency for the cooperative link, an indication of a quality of service associated with the cooperative link, or any combination thereof.
Aspect 4: The method of any of aspects 1 through 3, further comprising: transmitting, to the base station, one or more indications each corresponding to a respective criterion for the second UE.
Aspect 5: The method of aspect 4, wherein the one or more indications comprise an indication of a frequency band associated with a second direct link associated with the second UE, an indication of a transmit power associated with the second direct link, or any combination thereof.
Aspect 6: The method of any of aspects 1 through 5, further comprising: transmitting, to the base station, an indication of a location of the first UE, an indication of one or more locations associated with the cooperative link, an indication of the second UE, an indication of a group of UEs comprising the second UE, or any combination thereof.
Aspect 7: The method of any of aspects 1 through 6, further comprising: transmitting, to at least the second UE prior to transmitting the uplink signal, a sidelink UE discovery request signal to establish the cooperative link; monitoring for a response to the sidelink UE discovery request signal, wherein transmitting the uplink signal to the base station is based at least in part on failing to receive the response to the sidelink UE discovery request signal.
Aspect 8: A method for wireless communications at a second UE, comprising: receiving, from a base station and while operating in an idle mode, a UE discovery request signal corresponding to a first UE; transmitting, to the first UE, a sidelink signal based at least in part on receiving the UE discovery request signal from the base station, the sidelink signal indicating that the second UE is available for a cooperative link with the first UE; establishing the cooperative link with the first UE based at least in part on transmitting the sidelink signal; receiving downlink communications from the base station via a direct link with the base station; and transmitting sidelink communications to the first UE via the cooperative link, the sidelink communications corresponding to the downlink communications received from the base station.
Aspect 9: The method of aspect 8, further comprising: receiving the UE discovery request signal from the base station via a broadcast message.
Aspect 10: The method of aspect 9, wherein the broadcast message comprises a paging channel message, a system information message, a message communicated over a broadcast channel corresponding to UE cooperation, or any combination thereof.
Aspect 11: The method of any of aspects 8 through 10, further comprising: activating sidelink communications at the second UE in response to receiving the UE discovery request signal from the base station, wherein transmitting the sidelink signal is based at least in part on enabling the sidelink communications.
Aspect 12: The method of any of aspects 8 through 11, further comprising: receiving one or more indications each corresponding to a respective criterion for the cooperative link associated with the UE discovery request signal, a respective criterion for the second UE, or any combination thereof.
Aspect 13: The method of aspect 12, wherein the one or more indications comprise an indication of a sidelink type for the cooperative link, an indication of a latency for the cooperative link, an indication of a quality of service associated with the cooperative link, an indication of a frequency band associated with the direct link, an indication of a transmit power associated with the direct link, an indication of a location of the first UE, an indication of one or more locations associated with the cooperative link, an indication of the second UE, an indication of a group of UEs comprising the second UE, or any combination thereof.
Aspect 14: A method for wireless communications at a base station, comprising: receiving, from a first UE, an uplink signal indicating a request for the base station to transmit a UE discovery request signal to at least a second UE; transmitting, to at least the second UE and based at least in part on receiving the uplink signal, the UE discovery request signal corresponding to the first UE; receiving, from at least one of the first UE or the second UE, an indication of a cooperative link between the first UE and the second UE based at least in part on transmitting the UE discovery request signal; and transmitting, to the first UE and the second UE, downlink communications for the first UE via a first direct link with the first UE and a second direct link with the second UE.
Aspect 15: The method of aspect 14, further comprising: receiving, from the first UE, one or more indications each corresponding to a respective criterion for the cooperative link associated with the UE discovery request signal.
Aspect 16: The method of aspect 15, wherein the one or more indications comprise an indication of a sidelink type for the cooperative link, an indication of a latency for the cooperative link, an indication of a quality of service associated with the cooperative link, or any combination thereof.
Aspect 17: The method of any of aspects 14 through 16, further comprising: receiving, from the first UE, one or more indications each corresponding to a respective criterion for the second UE.
Aspect 18: The method of aspect 17, wherein the one or more indications comprise an indication of a frequency band associated with the second direct link, an indication of a transmit power associated with the second direct link, or any combination thereof, further comprising: receiving, from at least the second UE, a capability message indicating a capability of the second UE, wherein transmitting the UE discovery request signal to the second UE is based at least in part on the capability of the second UE satisfying the respective criterion for the second UE.
Aspect 19: The method of any of aspects 14 through 18, further comprising: receiving one or more indications from the first UE, the one or more indications comprising an indication of a location of the first UE, an indication of one or more locations associated with the cooperative link, an indication of the second UE, an indication of a group of UEs comprising the second UE, or any combination thereof, wherein transmitting the UE discovery request signal is based at least in part on receiving the one or more indications.
Aspect 20: The method of any of aspects 14 through 19, further comprising: transmitting, to at least the second UE, one or more indications each corresponding to a respective criterion for the cooperative link associated with the UE discovery request signal, a respective criterion for the second UE, or any combination thereof.
Aspect 21: The method of aspect 20, wherein the one or more indications comprise an indication of a sidelink type for the cooperative link, an indication of a latency for the cooperative link, an indication of a quality of service associated with the cooperative link, an indication of a frequency band associated with the second direct link, an indication of a transmit power associated with the second direct link, an indication of a location of the first UE, an indication of one or more locations associated with the cooperative link, an indication of the second UE, an indication of a group of UEs comprising the second UE, or any combination thereof.
Aspect 22: The method of any of aspects 14 through 21, further comprising: transmitting the UE discovery request signal to at least the second UE via a broadcast message.
Aspect 23: The method of aspect 22, wherein the broadcast message comprises a paging channel message, a system information message, a message communicated over a broadcast channel corresponding to UE cooperation, or any combination thereof.
Aspect 24: The method of any of aspects 14 through 23, further comprising: receiving, from the first UE, a request for multiple transmission reception point operation; selecting, based at least in part on receiving the request for multiple transmission reception point operation, a group of UEs based at least in part on each UE in the group of UEs being served by a first transmission reception point different than a second transmission reception point serving the first UE; and transmitting the UE discovery request signal to the selected group of UEs, the selected group of UEs comprising the second UE.
Aspect 25: The method of aspect 24, wherein transmitting the downlink communications comprises: transmitting the downlink communications via the first direct link associated with the second transmission reception point and via the second direct link associated with the first transmission reception point.
Aspect 26: The method of any of aspects 14 through 25, further comprising: receiving, from the first UE, a request for multiple user multiple input multiple output operation; selecting, based at least in part on receiving the request for multiple user multiple input multiple output operation, a group of UEs based at least in part on each UE in the group of UEs being served by a first beam different than a second beam serving the first UE, wherein a spatial separation between the first beam and the second beam satisfies a threshold; and transmitting the UE discovery request signal to the selected group of UEs, the selected group of UEs comprising the second UE.
Aspect 27: The method of aspect 26, wherein transmitting the downlink communications comprises: transmitting the downlink communications via the first direct link associated with the second beam and via the second direct link associated with the first beam.
Aspect 28: The method of any of aspects 14 through 27, further comprising: selecting a group of UEs based at least in part on each UE in the group of UEs being associated with a location for the cooperative link, a UE group identifier associated with the cooperative link, a UE identifier associated with the cooperative link, or any combination thereof; and transmitting the UE discovery request signal to the selected group of UEs, the selected group of UEs comprising the second UE.
Aspect 29: An apparatus for wireless communications at a first UE, comprising a processor; memory coupled with the processor; and instructions stored in the memory and executable by the processor to cause the apparatus to perform a method of any of aspects 1 through 7.
Aspect 30: An apparatus for wireless communications at a first UE, comprising at least one means for performing a method of any of aspects 1 through 7.
Aspect 31: A non-transitory computer-readable medium storing code for wireless communications at a first UE, the code comprising instructions executable by a processor to perform a method of any of aspects 1 through 7.
Aspect 32: An apparatus for wireless communications at a second UE, comprising a processor; memory coupled with the processor; and instructions stored in the memory and executable by the processor to cause the apparatus to perform a method of any of aspects 8 through 13.
Aspect 33: An apparatus for wireless communications at a second UE, comprising at least one means for performing a method of any of aspects 8 through 13.
Aspect 34: A non-transitory computer-readable medium storing code for wireless communications at a second UE, the code comprising instructions executable by a processor to perform a method of any of aspects 8 through 13.
Aspect 35: An apparatus for wireless communications at a base station, comprising a processor; memory coupled with the processor; and instructions stored in the memory and executable by the processor to cause the apparatus to perform a method of any of aspects 14 through 28.
Aspect 36: An apparatus for wireless communications at a base station, comprising at least one means for performing a method of any of aspects 14 through 28.
Aspect 37: A non-transitory computer-readable medium storing code for wireless communications at a base station, the code comprising instructions executable by a processor to perform a method of any of aspects 14 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples. Also, as used herein, the phrase “a set” shall be construed as including the possibility of a set with one member. That is, the phrase “a set” shall be construed in the same manner as “one or more.”

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor:
memory coupled with the processor; and
instructions stored in the memory and executable by the processor to cause the apparatus to:
transmit, to a base station, an uplink signal indicating a request for the base station to transmit a UE discovery request signal to at least a second UE:
receive, from the second UE, a sidelink signal based at least in part on transmitting the uplink signal, the sidelink signal indicating that the second UE is available for a cooperative link with the first UE:
establish the cooperative link with the second UE based at least in part on receiving the sidelink signal; and
receive downlink communications from the base station via at least sidelink communications from the second UE over the cooperative link based at least in part on establishing the cooperative link with the second UE.

2. The apparatus of claim 1, wherein the instructions are further executable by the processor to cause the apparatus to:
transmit, to the base station, one or more indications each corresponding to a respective criterion for the cooperative link associated with the UE discovery request signal.

3. The apparatus of claim 2, wherein the one or more indications comprise an indication of a sidelink type for the cooperative link, an indication of a latency for the cooperative link, an indication of a quality of service associated with the cooperative link, or any combination thereof.

4. The apparatus of claim 1, wherein the instructions are further executable by the processor to cause the apparatus to:
transmit, to the base station, one or more indications, each corresponding to a respective criterion for the second UE.

5. The apparatus of claim 4, wherein the one or more indications comprise an indication of a frequency band associated with a second direct link associated with the second UE, an indication of a transmit power associated with the second direct link, or any combination thereof.

6. The apparatus of claim 1, wherein the instructions are further executable by the processor to cause the apparatus to:
transmit, to the base station, an indication of a location of the first UE, an indication of one or more locations associated with the cooperative link, an indication of the second UE, an indication of a group of UEs comprising the second UE, or any combination thereof.

7. The apparatus of claim 1, wherein the instructions are further executable by the processor to cause the apparatus to:
transmit, to at least the second UE prior to transmitting the uplink signal, a sidelink UE discovery request signal to establish the cooperative link; and
monitor for a response to the sidelink UE discovery request signal, wherein transmitting the uplink signal to the base station is based at least in part on failing to receive the response to the sidelink UE discovery request signal.

8. An apparatus for wireless communications at a second user equipment (UE), comprising:
a processor:
memory coupled with the processor; and
instructions stored in the memory and executable by the processor to cause the apparatus to:
receive, from a base station and while operating in an idle mode, a UE discovery request signal corresponding to a first UE;
transmit, to the first UE, a sidelink signal based at least in part on receiving the UE discovery request signal from the base station, the sidelink signal indicating that the second UE is available for a cooperative link with the first UE;
establish the cooperative link with the first UE based at least in part on transmitting the sidelink signal:
receive downlink communications from the base station via a direct link with the base station; and
transmit sidelink communications to the first UE via the cooperative link, the sidelink communications corresponding to the downlink communications received from the base station.

9. The apparatus of claim 8, wherein the instructions are further executable by the processor to cause the apparatus to:
receive the UE discovery request signal from the base station via a broadcast message.

10. The apparatus of claim 9, wherein the broadcast message comprises a paging channel message, a system information message, a message communicated over a broadcast channel corresponding to UE cooperation, or any combination thereof.

11. The apparatus of claim 8, wherein the instructions are further executable by the processor to cause the apparatus to:
activate sidelink communications at the second UE in response to receiving the UE discovery request signal from the base station, wherein transmitting the sidelink signal is based at least in part on activating the sidelink communications.

12. The apparatus of claim 8, wherein the instructions are further executable by the processor to cause the apparatus to:
receive one or more indications each corresponding to a respective criterion for the cooperative link associated with the UE discovery request signal, a respective criterion for the second UE, or any combination thereof.

13. The apparatus of claim 12, wherein the one or more indications comprise an indication of a sidelink type for the cooperative link, an indication of a latency for the cooperative link, an indication of a quality of service associated with the cooperative link, an indication of a frequency band associated with the direct link, an indication of a transmit power associated with the direct link, an indication of a location of the first UE, an indication of one or more locations associated with the cooperative link, an indication of the second UE, an indication of a group of UEs comprising the second UE, or any combination thereof.

14. An apparatus for wireless communications at a base station, comprising:
a processor:
memory coupled with the processor; and
instructions stored in the memory and executable by the processor to cause the apparatus to:
receive, from a first user equipment (UE), an uplink signal indicating a request for the base station to transmit a UE discovery request signal to at least a second UE:
transmit, to at least the second UE and based at least in part on receiving the uplink signal, the UE discovery request signal corresponding to the first UE:
receive, from at least one of the first UE or the second UE, an indication of a cooperative link between the first UE and the second UE based at least in part on transmitting the UE discovery request signal; and
transmit, to the first UE and the second UE, downlink communications for the first UE via a first direct link with the first UE and a second direct link with the second UE.

15. The apparatus of claim 14, wherein the instructions are further executable by the processor to cause the apparatus to:
receive, from the first UE, one or more indications each corresponding to a respective criterion for the cooperative link associated with the UE discovery request signal.

16. The apparatus of claim 15, wherein the one or more indications comprise an indication of a sidelink type for the cooperative link, an indication of a latency for the cooperative link, an indication of a quality of service associated with the cooperative link, or any combination thereof.

17. The apparatus of claim 14, wherein the instructions are further executable by the processor to cause the apparatus to:
receive, from the first UE, one or more indications each corresponding to a respective criterion for the second UE.

18. The apparatus of claim 17, wherein the one or more indications comprise an indication of a frequency band associated with the second direct link, an indication of a transmit power associated with the second direct link, or any combination thereof, and wherein the instructions are further executable by the processor to cause the apparatus to:
receive, from at least the second UE, a capability message indicating a capability of the second UE, wherein transmitting the UE discovery request signal to the second UE is based at least in part on the capability of the second UE satisfying the respective criterion for the second UE.

19. The apparatus of claim 14, wherein the instructions are further executable by the processor to cause the apparatus to:
receive one or more indications from the first UE, the one or more indications comprising an indication of a location of the first UE, an indication of one or more locations associated with the cooperative link, an indication of the second UE, an indication of a group of UEs comprising the second UE, or any combination thereof, wherein transmitting the UE discovery request signal is based at least in part on receiving the one or more indications.

20. The apparatus of claim 14, wherein the instructions are further executable by the processor to cause the apparatus to:
transmit, to at least the second UE, one or more indications each corresponding to a respective criterion for the cooperative link associated with the UE discovery request signal, a respective criterion for the second UE, or any combination thereof.

21. The apparatus of claim 20, wherein the one or more indications comprise an indication of a sidelink type for the cooperative link, an indication of a latency for the cooperative link, an indication of a quality of service associated with the cooperative link, an indication of a frequency band associated with the second direct link, an indication of a transmit power associated with the second direct link, an indication of a location of the first UE, an indication of one or more locations associated with the cooperative link, an indication of the second UE, an indication of a group of UEs comprising the second UE, or any combination thereof.

22. The apparatus of claim 14, wherein the instructions are further executable by the processor to cause the apparatus to:
transmit the UE discovery request signal to at least the second UE via a broadcast message.

23. The apparatus of claim 22, wherein the broadcast message comprises a paging channel message, a system information message, a message communicated over a broadcast channel corresponding to UE cooperation, or any combination thereof.

24. The apparatus of claim 14, wherein the instructions are further executable by the processor to cause the apparatus to:
receive, from the first UE, a request for multiple transmission reception point operation:
select, based at least in part on receiving the request for multiple transmission reception point operation, a group of UEs based at least in part on each UE in the group of UEs being served by a first transmission reception point different than a second transmission reception point serving the first UE; and
transmit the UE discovery request signal to the selected group of UEs, the selected group of UEs comprising the second UE.

25. The apparatus of claim 24, wherein, to transmit the downlink communications, the instructions are executable by the processor to cause the apparatus to:
transmit the downlink communications via the first direct link associated with the second transmission reception point and via the second direct link associated with the first transmission reception point.

26. The apparatus of claim 14, wherein the instructions are further executable by the processor to cause the apparatus to:
receive, from the first UE, a request for multiple user multiple input multiple output operation:
select, based at least in part on receiving the request for multiple user multiple input multiple output operation, a group of UEs based at least in part on each UE in the group of UEs being served by a first beam different than a second beam serving the first UE, wherein a spatial separation between the first beam and the second beam satisfies a threshold; and
transmit the UE discovery request signal to the selected group of UEs, the selected group of UEs comprising the second UE.

27. The apparatus of claim 26, wherein, to transmit the downlink communications, the instructions are executable by the processor to cause the apparatus to:
transmit the downlink communications via the first direct link associated with 3 the second beam and via the second direct link associated with the first beam.

28. The apparatus of claim 14, wherein the instructions are further executable by the processor to cause the apparatus to:
select a group of UEs based at least in part on each UE in the group of UEs being associated with a location for the cooperative link, a UE group identifier associated 4 with the cooperative link, a UE identifier associated with the cooperative link, or any combination thereof; and
transmit the UE discovery request signal to the selected group of UEs, the selected group of UEs comprising the second UE.

29. A method for wireless communications at a first user equipment (UE), comprising:
transmitting, to a base station, an uplink signal indicating a request for the base station to transmit a UE discovery request signal to at least a second UE;
receiving, from the second UE, a sidelink signal based at least in part on transmitting the uplink signal, the sidelink signal indicating that the second UE is available for a cooperative link with the first UE;
establishing the cooperative link with the second UE based at least in part on receiving the sidelink signal; and
receiving downlink communications from the base station via at least sidelink communications from the second UE over the cooperative link based at least in part on establishing the cooperative link with the second UE.

30. The method of claim 29, further comprising:
transmitting, to the base station, one or more indications each corresponding to a respective criterion for the cooperative link associated with the UE discovery request signal.
